(19) United States
(12) Patent Application Publication
(10) Pub. No.: US 2026/0341213 A1
(43) Pub. Date: Oct. 29, 2026

(54) PIXEL CIRCUIT AND DRIVING METHOD THEREOF

(71) Applicant: Beijing Visionox Technology Co., Ltd., Beijing (CN)

(72) Inventors: Enqing GUO, Beijing (CN); Cuili GAI, Beijing (CN); Jianjun LU, Beijing (CN); Shuang GUO, Beijing (CN)

(73) Assignee: Beijing Visionox Technology Co., Ltd., Beijing (CN)

(21) Appl. No.: 19/716,077

(22) Filed: Jun. 22, 2026

(30) Foreign Application Priority Data
Jun. 27, 2025 (CN) 202510887435.0

(51) Int. Cl. G09G 3/3233

(52) U.S. Cl. CPC G09G 3/3233; G09G 2300/0819; G09G 2300/0842; G09G 2310/08; G09G 2320/0233; G09G 2320/0247; G09G 2320/045; G09G 2330/021

(57) ABSTRACT

The present application discloses a pixel circuit and a driving method thereof. The pixel circuit includes: a driving module, a coupling module, a compensation module, and a voltage writing module; a first terminal of the compensation module is connected to a first terminal of the driving module, a second terminal of the compensation module is connected to a control terminal of the driving module, and the compensation module is configured to transmit a threshold voltage information of the driving module to the driving module; the coupling module is connected between the voltage writing module and the first terminal of the driving module, and is electrically configured to time-divisionally transmit a first initialization voltage and a data voltage to the coupling module; the coupling module is configured to couple a voltage containing the data voltage to the control terminal of the driving module.

### CROSS-REFERENCE TO RELATED APPLICATIONS

This application claims priority to Chinese Patent Application No. 202510887435.0, filed on Jun. 27, 2025, which is incorporated herein by reference in its entirety.

### FIELD

The present application relates to the field of display technology, and in particular, to a pixel circuit and a driving method thereof.

### BACKGROUND

With the development of display technology, there is an increasing demand for display panels. A display panel typically includes a plurality of pixel circuits, each pixel circuit including a driving transistor that generates a driving signal to drive a light-emitting device to emit light. However, existing pixel circuits cannot simultaneously achieve multiple excellent performances, making it difficult for existing display panels to meet user requirements.

### SUMMARY

The present application provides a pixel circuit and a driving method thereof to solve the problem that a display panel cannot simultaneously achieve multiple excellent performances.

According to one aspect of the present application, a pixel circuit is provided, including a driving module, a coupling module, a compensation module, and a voltage writing module.

A first terminal of the compensation module is connected to a first terminal of the driving module, and a second terminal of the compensation module is connected to a control terminal of the driving module. The compensation module is configured to transmit threshold voltage information of the driving module to the control terminal of the driving module, the threshold voltage of the driving module is formed after the driving module performs discharging.

A first terminal of the coupling module is connected to the voltage writing module, and a second terminal of the coupling module is connected to the first terminal of the driving module. The voltage writing module is configured to transmit a first initialization voltage and a data voltage to the first terminal of the coupling module in a time-division manner.

The coupling module is configured to couple a voltage containing the data voltage to the control terminal of the driving module.

Transistors included in the driving module and transistors included in the compensation module are oxide transistors. The voltage writing module includes at least one transistor, and at least one transistor in the voltage writing module is a low-temperature polysilicon transistor.

According to another aspect of the present application, a pixel circuit is also provided, including: a driving module, a compensation module, a first light-emitting control module, a second light-emitting control module, an anode reset module, and a light-emitting module.

A first terminal of the compensation module is connected to a first terminal of the driving module, and a second terminal of the compensation module is connected to a control terminal of the driving module. The compensation module is configured to transmit threshold voltage information of the driving module to the control terminal of the driving module, the threshold voltage of the driving module is formed after the driving module performs discharging.

The first light-emitting control module, the driving module, the second light-emitting control module, and the light-emitting module are sequentially connected in series between a first power supply and a second power supply. The first light-emitting control module is configured to be turned on in response to a first light-emitting control signal.

The anode reset module is configured to provide a second initialization voltage to a first terminal of the light-emitting module in response to a first scan signal.

A transistor type of the first light-emitting control module is opposite to a transistor type of the anode reset module.

The first light-emitting control signal is multiplexed as the first scan signal;

or, in a display panel corresponding to the pixel circuit, pixel circuits are arranged in an array. First light-emitting control modules of pixel circuits located in a same row are connected to the same first light-emitting control signal. Anode reset modules of pixel circuits located in the same row are connected to the same first scan signal. In adjacent two rows of pixel circuits, the first light-emitting control signal connected to pixel circuits in a previous row is multiplexed as the first scan signal connected to pixel circuits in a next row.

According to another aspect of the present application, a driving method of a pixel circuit is also provided, and one display period of the pixel circuit includes at least a write frame.

The driving method of the pixel circuit includes:
In a first initialization phase of the write frame, the voltage writing module provides the first initialization voltage to the first terminal of the coupling module in response to a second scan signal.

In a threshold compensation phase of the write frame, the compensation module is turned on in response to a fourth scan signal to transmit threshold voltage information of the driving module to the control terminal of the driving module, the threshold voltage of the driving module is formed after the driving module performs discharging.

In a data writing phase of the write frame, the voltage writing module provides the data voltage to the first terminal of the coupling module in response to a third scan signal, and the coupling module couples a voltage containing the data voltage to the control terminal of the driving module.

The embodiments of the present application compensate for the threshold voltage of the driving module through the compensation module, avoiding the influence of threshold voltage drift on display uniformity. The coupling module couples the data voltage written by the voltage writing module to the control terminal of the driving module via the compensation module, achieving the writing of the data voltage and the driving module subsequently generates a driving current based on the data voltage to drive the light-emitting module to emit light. Transistors included in the driving module and the compensation module are all oxide transistors. Oxide transistors have low leakage current in the off state, and the compensation module is connected to the control terminal of the driving module. The compensation module has low leakage current in the off state, resulting in a small change in the potential of the control terminal of the driving module, thereby ensuring good display uniformity. At least one transistor in the voltage writing module is a low-temperature polysilicon transistor. Low-temperature polysilicon transistors have high mobility and fast switching speed, improving display reliability, and low-temperature polysilicon transistors do not require a large voltage drop for driving, thereby facilitating reduction of panel power consumption. The pixel circuit in this embodiment includes both oxide transistors and low-temperature polysilicon transistors, which can balance display uniformity and low power consumption of the panel.

### BRIEF DESCRIPTION OF THE DRAWINGS

To more clearly illustrate the embodiments of the present application, the following briefly introduces the drawings required for describing the embodiments. In one embodiment, the drawings in the following description are only some embodiments of the present application.

FIG. 1 is a schematic structural diagram of a pixel circuit according to an embodiment of the present application;

FIG. 2 is a schematic structural diagram of another pixel circuit according to an embodiment of the present application;

FIG. 3 is a driving timing diagram of a pixel circuit according to an embodiment of the present application;

FIG. 4 is a schematic structural diagram of another pixel circuit according to an embodiment of the present application;

FIG. 5 is a simulation waveform diagram of an operating process of a pixel circuit according to an embodiment of the present application;

FIG. 6 is a schematic structural diagram of another pixel circuit according to an embodiment of the present application;

FIG. 7 is a schematic structural diagram of another pixel circuit according to an embodiment of the present application;

FIG. 8 is a driving timing diagram of another pixel circuit according to an embodiment of the present application;

FIG. 9 is a schematic structural diagram of another pixel circuit according to an embodiment of the present application;

FIG. 10 is a schematic structural diagram of another pixel circuit according to an embodiment of the present application;

FIG. 11 is a driving timing diagram of another pixel circuit according to an embodiment of the present application;

FIG. 12 is a schematic structural diagram of another pixel circuit according to an embodiment of the present application;

FIG. 13 is a schematic structural diagram of another pixel circuit according to an embodiment of the present application;

FIG. 14 is a driving timing diagram of another pixel circuit according to an embodiment of the present application;

FIG. 15 is a schematic structural diagram of another pixel circuit according to an embodiment of the present application;

FIG. 16 is a schematic structural diagram of another pixel circuit according to an embodiment of the present application;

FIG. 17 is a driving timing diagram of another pixel circuit according to an embodiment of the present application;

FIG. 18 is a simulation waveform diagram of an operating process of another pixel circuit according to an embodiment of the present application;

FIG. 19 is a schematic structural diagram of another pixel circuit according to an embodiment of the present application;

FIG. 20 is a schematic structural diagram of another pixel circuit according to an embodiment of the present application;

FIG. 21 is a driving timing diagram of another pixel circuit according to an embodiment of the present application;

FIG. 22 is a schematic structural diagram of another pixel circuit according to an embodiment of the present application;

FIG. 23 is a flowchart of a driving method of a pixel circuit according to an embodiment of the present application.

### DETAILED DESCRIPTION

To enable a better understanding of the solutions of the present application, the embodiments of the present application will be clearly and completely described below with reference to the accompanying drawings in the embodiments of the present application. In one embodiment, the described embodiments are only a part of the embodiments of the present application, not all of them.

As described in the background, existing display panels have relatively single performance and cannot simultaneously achieve multiple excellent properties, such as balancing low power consumption and display uniformity. Through research, the inventors found that the reason is that the types of transistors included in the pixel circuits in existing display panels are relatively single. In one embodiment, the pixel circuit includes a plurality of transistors. Taking a common 7T1C (7 transistors and 1 capacitor) pixel circuit as an example, all transistors included in the pixel circuit are oxide transistors, and the leakage current of the transistor connected to the gate of the driving transistor is small, thereby reducing the magnitude of the leakage current at the gate of the driving transistor, maintaining the stability of the gate potential, and improving display uniformity. In one embodiment, all transistors included in the pixel circuit are low-temperature polysilicon transistors, which have high mobility, fast switching speed, high reliability, and a small driving voltage across the low-temperature polysilicon transistor, which is beneficial for reducing panel power consumption. Therefore, existing pixel circuits have relatively single functionality and cannot meet increasingly high display requirements.

In view of the above problems, embodiments of the present application provide a novel pixel circuit. The pixel circuit includes both oxide transistors and low-temperature polysilicon transistors, simultaneously leveraging the advantages of small leakage current of oxide transistors and high stability, high mobility, and low power consumption of low-temperature polysilicon transistors.

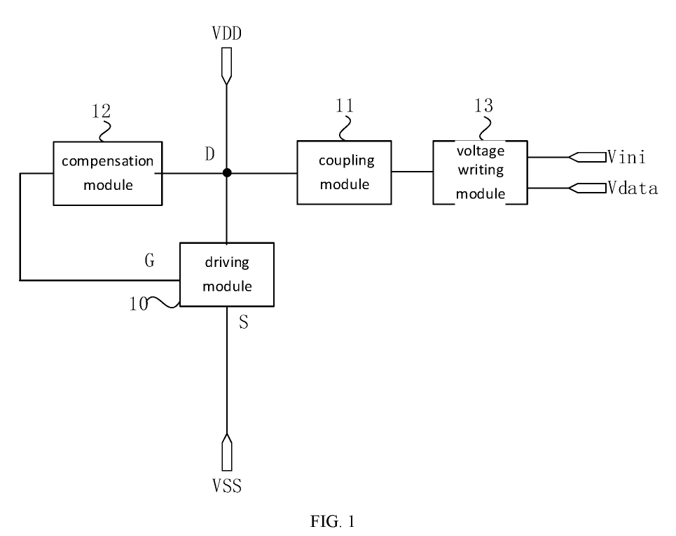

FIG. 1 is a schematic structural diagram of a pixel circuit according to an embodiment of the present application. Referring to FIG. 1, the pixel circuit includes: a driving module 10, a coupling module 11, a compensation module 12, and a voltage writing module 13.

A first terminal of the compensation module 12 is connected to a first terminal D of the driving module 10, and a second terminal of the compensation module 12 is connected to a control terminal G of the driving module 10. The compensation module 12 is configured to transmit threshold voltage information of the driving module 10 to the control terminal G of the driving module 10, the threshold voltage of the driving module is formed after the driving module performs discharging.

A first terminal of the coupling module 11 is connected to the voltage writing module 13, and a second terminal of the coupling module 11 is connected to the first terminal of the driving module 10. The voltage writing module 13 is configured to transmit a first initialization voltage and a data voltage to the first terminal of the coupling module 11 in a time-division manner.

The coupling module 11 is configured to couple the data voltage Vdata to the control terminal of the driving module 10.

Transistors included in the driving module 10 and transistors included in the compensation module 12 are all oxide transistors. The voltage writing module 13 includes at least one transistor, and at least one transistor in the voltage writing module 13 is a low-temperature polysilicon transistor.

In one embodiment, the second terminal S of the driving module 10 is directly or indirectly connected to the second power supply VSS, and the first terminal D of the driving module 10 is directly or indirectly connected to the first power supply VDD. The voltage of the first power supply VDD is greater than the voltage of the second power supply VSS. When compensating for the threshold voltage of the driving module 10, the compensation module 12 is turned on. The potential of the control terminal of the driving module 10 is equal to the potential of the first terminal D of the driving module 10, and there is a potential difference between the potential of the first terminal D and the second terminal S of the driving module 10. The first terminal D of the driving module 10 discharges to the second terminal S of the driving module 10 until the potential difference between the control terminal G and the second terminal S of the driving module 10 is equal to Vth, at which point the driving module 10 is turned off, the discharge stops, and the threshold voltage compensation is completed, where Vth is the threshold voltage of the transistor included in the driving module.

The voltage writing module 13 is used to transmit the first initialization voltage Vini to the first terminal of the coupling module 11 during a first initialization phase to reset the coupling module 11, and is also used to write the data voltage Vdata to the first terminal of the coupling module 11 during a data writing phase. Here, the first initialization voltage Vini is written to the first terminal of the coupling module 11 before the data voltage Vdata. The voltage jump at the first terminal of the coupling module 11 is (Vdata-Vini). According to the voltage coupling characteristics of the coupling module 11, during the data writing phase, the coupling module 11 couples (Vdata-Vini) to the control terminal of the driving module 10, thereby coupling a voltage containing the data voltage Vdata to the control terminal of the driving module 10, achieving the writing of the data voltage. In one embodiment, the voltage writing module 13 includes only one transistor. The first electrode of the transistor is respectively connected to a first initialization signal line for transmitting the first initialization voltage Vini and a data line for transmitting the data voltage Vdata. During the first initialization phase, the first initialization signal line outputs the first initialization voltage Vini, and the data line does not output a voltage. During the data writing phase, the data line outputs the data voltage Vdata, and the first initialization signal line does not output a voltage, thereby transmitting the first initialization voltage Vini and the data voltage Vdata to the first terminal of the coupling module 11 in a time-division manner through one transistor. In other embodiments, the voltage writing module 13 may include two transistors, one transistor connected to the first initialization signal line for transmitting the first initialization voltage Vini, and the other connected to the data line for transmitting the data voltage Vdata, thereby turning on the two transistors in a time-division manner to transmit the first initialization voltage Vini and the data voltage Vdata to the coupling module 11 in a time-division manner. In one embodiment, the voltage writing module 13 may include three transistors, where one transistor is used to turn on during the first initialization phase to transmit the first initialization voltage Vini to the coupling module 11, and the other two transistors are connected in series with their gates receiving the same signal, used to turn on during the data writing phase to transmit the data voltage Vdata to the coupling module 11.

In one embodiment, the compensation module 12 includes one transistor, and the included one transistor is an oxide transistor, and after the data voltage writing is completed and the compensation module 12 is turned off, the off-state current of the compensation module 12 is small, thereby reducing the voltage variation at the control terminal G of the driving module 10, which is beneficial for maintaining the stability of the potential at the control terminal G, thereby improving display uniformity. In other embodiments, the compensation module 12 may also include at least two transistors, and all transistors included in the compensation module 12 are oxide transistors.

In one embodiment, the voltage writing module 13 includes two transistors, one transistor used to transmit the first initialization voltage Vini to the first terminal of the coupling module 11 after being turned on, and the other used to transmit the data voltage Vdata to the first terminal of the coupling module 11 after being turned on, and the two transistors are not turned on simultaneously. At least one of the at least two transistors included in the voltage writing module 13 is a low-temperature polysilicon transistor, which can improve the reliability of the circuit, and at the same time, the driving transconductance of the low-temperature polysilicon transistor is small, which is beneficial for reducing screen power consumption.

In one embodiment of the present application, the threshold voltage of the driving module is compensated by the compensation module to avoid the influence of threshold voltage drift on display uniformity. The data voltage written by the voltage writing module is coupled to the control terminal of the driving module via the compensation module through the coupling module, achieving the writing of the data voltage and the subsequent driving module generates a driving current to drive the light-emitting module to emit light based on the data voltage. The transistors included in the driving module and the compensation module are all oxide transistors. The leakage current of oxide transistors in the off state is small, and since the compensation module is connected to the control terminal of the driving module, the leakage current of the compensation module in the off state is small, resulting in a small potential change at the control terminal of the driving module, thereby providing better display uniformity. Among the at least two transistors included in the voltage writing module, at least one transistor is a low-temperature polysilicon transistor. Low-temperature polysilicon transistors have high mobility and fast switching speed, improving display reliability, and low-temperature polysilicon transistors do not require a large transconductance drive, which is beneficial for reducing screen power consumption. The pixel circuit in this embodiment includes both oxide transistors and low-temperature polysilicon transistors, which can balance display uniformity and low power consumption of the screen.

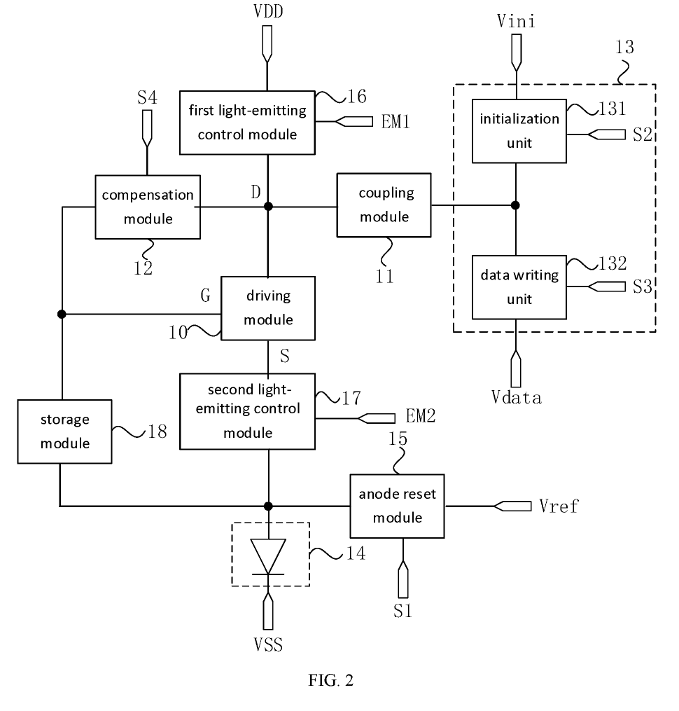

FIG. 2 is a schematic structural diagram of another pixel circuit provided in an embodiment of the present application. Referring to FIG. 2, the pixel circuit further includes: a light-emitting module 14 and an anode reset module 15. The anode reset module 15 is connected to the first terminal of the light-emitting module 14 and is used to provide a second initialization voltage Vref to the first terminal of the light-emitting module 14 in response to a first scan signal S1.

The anode reset module 15 is a switching module, with its control terminal receiving the first scan signal S1, configured to, in response to the first scan signal S1 being turned on, apply the second initialization voltage Vref to the first terminal of the light-emitting module 14, thereby resetting the light-emitting module 14 to avoid the influence of residual charges from a previous display frame on the current display frame. The light-emitting module 14 can be an OLED device, the first terminal of the light-emitting module 14 can be the anode of the OLED device, and the second terminal of the light-emitting module 14 is the cathode of the OLED device.

Continuing to refer to FIG. 2, in one embodiment, the turn-on frequency of the anode reset module 15 is greater than the turn-on frequency of the compensation module 12.

When the compensation module 12 is turned on, the coupling module 11 can couple a voltage related to the data voltage to the control terminal G of the driving module 10, completing the writing of the data voltage. In one embodiment, the turn-on frequency of the compensation module 12 is equal to the refresh frequency of the pixel circuit, and the refresh frequency of the pixel circuit is the frequency at which the voltage related to the data voltage is written to the control terminal G of the driving module 10. The turn-on frequency of the anode reset module 15 is greater than the turn-on frequency of the compensation module 12, or greater than the refresh frequency of the pixel circuit, and the first terminal of the light-emitting module 14 can be reset at a frequency greater than the refresh frequency of the pixel circuit. High-frequency resetting of the light-emitting module 14 can shorten the black-state time interval of the light-emitting module 14, making the user less sensitive to flicker, improving the flicker problem caused by resetting the first terminal of the light-emitting module 14 at low frequencies, and enhancing display quality.

Continuing to refer to FIG. 2, in one embodiment, one display cycle of the pixel circuit includes a write frame F1 and a hold frame F2;

the anode reset module 15 is configured to, in a second initialization phase of the write frame, in response to the first scan signal S1, provide the second initialization voltage to the first terminal of the light-emitting module 14, and is further configured to, in a second initialization phase of the hold frame, in response to the first scan signal S1, provide the second initialization voltage Vref to the first terminal of the light-emitting module 14; the compensation module 12 is configured to be turned off in the hold frame.

One display cycle of the pixel circuit can be understood as the time interval from the previous write frame to the next write frame. In the write frame, the data voltage is written, i.e., the voltage related to the data voltage is coupled to the control terminal G of the driving module 10; in the hold frame, the compensation module 12 is turned off, and no data voltage is written, i.e., the voltage related to the data voltage is not coupled to the control terminal G of the driving module 10.

In the write frame and the hold frame, the turn-on frequency of the anode reset module 15 is the same. Whether in the write frame or the hold frame, the first terminal of the light-emitting module 14 is reset once, and even if the refresh frequency is low, high-frequency reset of the light-emitting module 14 can still be achieved, which is beneficial for eliminating the low-frequency flicker problem at low refresh rates.

Continuing to refer to FIG. 2, in one embodiment, one display cycle of the pixel circuit includes a write frame and a hold frame; the pixel circuit further includes a first light emission control module 16 and a second light emission control module 17;

A first terminal of the first light emission control module 16 is connected to a first power supply VDD, a second terminal of the first light emission control module 16 is connected to a first terminal D of the driving module 10, a first terminal of the second light emission control module 17 is connected to a second terminal S of the driving module 10, a second terminal of the second light emission control module 17 is connected to the first terminal of the light-emitting module 14, a control terminal of the first light emission control module 16 receives a first light emission control signal EM1, and a control terminal of the second light emission control module 17 receives a second light emission control signal EM2.

The first light emission control module 16 is configured to be turned on in response to the first light emission control signal EM1 in both the light emission phase of the write frame and the light emission phase of the hold frame, and the second light emission control module 17 is configured to be turned on in response to the second light emission control signal EM2 in both the light emission phase of the write frame and the light emission phase of the hold frame.

The first light emission control module 16 and the second light emission control module 17 are both switching modules, which, when turned on, connect the first terminal and the second terminal of the module. Whether in the write frame or the hold frame, the light-emitting module 14 needs to emit light; therefore, in the light emission phase, after the first light emission control module 16 and the second light emission control module 17 are each turned on in response to the signal received at their control terminals, the driving module 10 drives the light-emitting module 14 to emit light using a driving current generated based on the data voltage.

In one embodiment, the hold frame includes a light emission phase and a black insertion phase; in the black insertion phase, the first light emission control module 16 is turned off in response to the first light emission control signal EM1, and the second light emission control module 17 is turned on in response to the second light emission control signal EM2. The light emission phase of the hold frame is used for display, so both the first light emission control module 16 and the second light emission control module 17 are turned on to form a path for the driving current to flow, enabling the light-emitting module 14 to emit light. In the black insertion phase of the hold frame, the first light emission control module 16 is turned off to block the path for the driving current to flow, and the light-emitting module 14 does not emit light.

Continuing to refer to FIG. 2, in one embodiment, the voltage writing module 13 includes an initialization unit 131 and a data writing unit 132. The initialization unit 131 is connected to the first terminal of the coupling module 11, and a control terminal of the initialization unit 131 receives a second scan signal S2, configured to, in a first initialization phase of the write frame, in response to the second scan signal S2, provide a first initialization voltage Vini to the first terminal of the coupling module 11.

The data writing unit 132 is connected to the first terminal of the coupling module 11, and a control terminal of the data writing unit 132 receives a third scan signal S3, configured to, in a data writing phase of the write frame, in response to the third scan signal S3, provide a data voltage Vdata to the first terminal of the coupling module 11. The coupling module 11 is configured to transmit a voltage containing the data voltage Vdata to the control terminal G of the driving module 10 via the turned-on compensation module 12.

The initialization unit 131 and the data writing unit 132 are both switching units, which connect the two ends of the unit when turned on. In one embodiment, in the first initialization phase of a write frame, the initialization unit 131 is turned on in response to the second scan signal S2 to provide the first initialization voltage Vini to the first terminal of the coupling module 11, while the data writing unit 132 is turned off in response to the third scan signal S3. In the data writing phase of the write frame, the initialization unit 131 is turned off in response to the second scan signal S2, and the data writing unit 132 is turned on in response to the third scan signal S3 to provide the data voltage Vdata to the first terminal of the coupling module 11. Within the write frame, the first initialization phase and the data writing phase are not performed simultaneously, and the first initialization phase precedes the data writing phase. After the first initialization voltage Vini is written to the first terminal of the coupling module 11, and subsequently the data voltage Vdata is written, a voltage jump occurs at the first terminal of the coupling module 11, thereby coupling the voltage jump amount (Vdata-Vini) to the second terminal of the coupling module 11, i.e., the first terminal D of the driving module 10, and then transmitting the voltage jump amount (Vdata-Vini) to the control terminal G of the driving module 10 through the turned-on compensation module.

Continuing to refer to FIG. 2, in one embodiment, the control terminal of the compensation module 12 is connected to the fourth scan signal S4, and is configured to be turned on in response to the fourth scan signal S4 during the threshold compensation phase of the write frame, to transmit the threshold voltage information of the driving module 10 to the control terminal G of the driving module 10, based on the voltage at the first terminal of the driving module 10 after it is discharged through the driving module 10, the second emission control module 17, and the anode reset module 15.

The second emission control module 17 is configured to be turned on in response to the second emission control signal EM2 during the threshold compensation phase of the write frame. The anode reset module 15 is configured to be turned on in response to the first scan signal S1 during the threshold compensation phase of the write frame. This causes the first terminal D of the driving module 10 to discharge to the second initialization voltage Vref through the second emission control module 17 and the anode reset module 15. The discharge continues until the potential of the control terminal G of the driving module 10 equals Vref+Vth, at which point the driving module 10 is turned off, the discharge ends, and the threshold compensation is completed.

In one embodiment, for any write frame, the threshold compensation phase and the data writing phase partially overlap. There is an overlapping portion between the threshold compensation phase and the data writing phase, and the data writing unit 132 and the compensation module 12 are turned on simultaneously, thereby allowing the voltage containing the data voltage to be transmitted to the control terminal G of the driving module 10 through the coupling module 11 and the turned-on compensation module 12.

The start time of the threshold compensation phase is earlier than the start time of the data writing phase, and the end time of the threshold compensation phase is earlier than the end time of the data writing phase.

The threshold compensation phase precedes the data writing phase, and the threshold voltage of the transistor included in the driving module 10 is compensated first during the threshold compensation phase. After the threshold voltage compensation is performed in the threshold compensation phase, the data writing phase begins. In the data writing phase, the compensation module 12 is also turned on for a period of time, and the data writing unit 132 is turned on in response to the third scan signal S3 to write the data voltage Vdata to the first terminal of the coupling module 11, and then the coupling module 11 couples the voltage related to the data voltage to the control terminal G of the driving module 10 through the turned-on compensation module 12, thereby achieving the writing of the data voltage. The threshold compensation phase precedes the data writing phase, and the threshold voltage compensation process and the data voltage writing process are separated, and the duration of the threshold compensation phase is not limited by the duration of the data writing phase, avoiding insufficient threshold compensation when the threshold compensation and data writing are performed in the same phase at a high refresh rate due to the short duration of the data writing phase, which would affect display uniformity. In this embodiment, separating the writing of the data voltage and the compensation of the threshold voltage allows for sufficient compensation of the threshold voltage of the driving module 10 at a high refresh rate, achieving wide-frequency driving and improving display uniformity.

In one embodiment, for any write frame, the threshold compensation phase and the first initialization phase partially overlap, and the end time of the threshold compensation phase is later than the end time of the first initialization phase. For any write frame, the second initialization phase and the threshold compensation phase partially overlap, and the start time of the second initialization phase is the same as the start time of the threshold compensation phase, and the end time of the second initialization phase is later than the end time of the threshold compensation phase, or the start time of the second initialization phase is earlier than the start time of the threshold compensation phase, and the end time of the second initialization phase is the same as the end time of the threshold compensation phase.

Continuing to refer to FIG. 2, in one embodiment, the compensation module 12 is further configured to be turned on first and then turned off in response to the fourth scan signal S4 during the data writing phase of the write frame, to transmit the voltage containing the data voltage to the control terminal G of the driving module 10.

During the data writing phase, the compensation module 12 is turned on in response to the fourth scan signal S4 to transmit the voltage containing the data voltage to the control terminal G of the driving module 10, thereby writing the data voltage to the control terminal G of the driving module 10. Subsequently, the compensation module 12 is turned off in response to the fourth scan signal S4, and the potential of the control terminal G of the driving module 10 maintains the voltage written at the last moment before the compensation module 12 is turned off. Therefore, even if the data voltage Vdata changes at a high frequency, as long as the voltage written by the data writing unit 132 at the moment when the compensation module 12 transitions from on to off is the voltage required for the current display, the data voltage will not be written to the control terminal of the driving module 10 after the compensation module 12 is turned off, even if it changes. This enables high-frequency driving of the pixel circuit.Furthermore, in the data writing phase of any write frame, the on-duration of the compensation module 12 is equal to the off-duration of the compensation module 12, and the coupling module 11 fully couples the voltage containing the data voltage to the control terminal G of the driving module 10 through the compensation module 12.

Continuing to refer to FIG. 2, in one embodiment, the type of transistor included in the first emission control module 16 is opposite to the type of transistor included in the anode reset module 15, and the first emission control signal EM1 is reused as the first scan signal S1.

The transistors included in the first light emission control module 16 are of an opposite type to the transistors included in the anode reset module 15. The first light emission control signal EM1 is multiplexed as the first scan signal S1. When the first light emission control module 16 is turned on, the anode reset module 15 is turned off; when the first light emission control module 16 is turned off, the anode reset module 15 is turned on. Multiplexing the first light emission control signal EM1 as the first scan signal S1 simplifies the circuit structure, reduces the number of signal lines, and is beneficial for increasing pixel density.

In one embodiment, the transistors included in the first light emission control module 16 are P-type transistors, and the transistors included in the anode reset module 15 are N-type transistors. Further, the transistors included in the first light emission control module 16 are low-temperature polysilicon transistors, and the transistors included in the anode reset module 15 are oxide transistors.

The transistors included in the first light emission control module 16 are low-temperature polysilicon transistors. Low-temperature polysilicon transistors have high reliability, small characteristic drift, and small threshold voltage variation, which results in a smaller impact on the driving current, reducing the degree of driving current degradation and being beneficial for improving the current lifetime of the panel.

Continuing to refer to FIG. 2, in one embodiment, the type of transistors included in the second light emission control module 17 is the same as the type of transistors included in the initialization unit 131. The second light emission control signal EM2 is multiplexed as the second scan signal S2.

When the second light emission control module 17 is turned on, the initialization unit 131 is also turned on; when the second light emission control module 17 is turned off, the initialization unit 131 is turned off. Multiplexing the second light emission control signal EM2 as the second scan signal S2 can further simplify the circuit structure, reduce the number of signal lines, and further increase pixel density.

In one embodiment, the transistors included in the second light emission control module 17 and the transistors included in the initialization unit 131 are both P-type transistors. Further, the transistors included in the second light emission control module 17 and the transistors included in the initialization unit 131 are both low-temperature polysilicon transistors. The transistors included in the data writing unit 132 are P-type transistors; the transistors included in the data writing unit 132 are low-temperature polysilicon transistors.

In one embodiment, the pixel circuit further includes a storage module 18 connected between the control terminal G of the driving module 10 and the first terminal of the light emitting module 14.

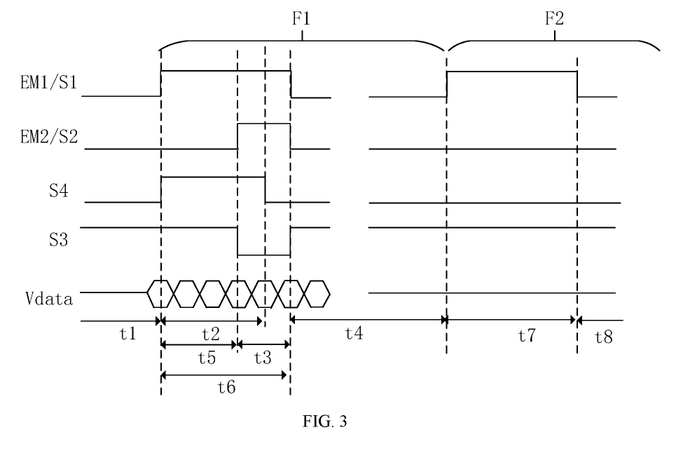

FIG. 3 is a driving timing diagram of a pixel circuit provided in an embodiment of the present application. Referring to FIGS. 2 and 3, in this embodiment, the transistors included in the driving module 10, the transistors included in the compensation module 12, and the transistors included in the anode reset module 15 are all N-type transistors, and the transistors included in the first light emission control module 16, the transistors included in the second light emission control module 17, the transistors included in the initialization unit 131, and the transistors included in the data writing unit 132 are all P-type transistors as an example. Among them, the N-type transistor is turned on when the gate is at a high level and turned off when the gate is at a low level; the P-type transistor is turned on when the gate is at a low level and turned off when the gate is at a high level. The write frame F1 includes a first initialization phase t5, a second initialization phase t6, a threshold compensation phase t2, a data writing phase t3, and a light emitting phase t4. The hold frame F2 includes a second initialization phase and a light emitting phase t8.

In FIG. 3, the initial phase t1 is the light emitting phase of the previous display frame. The first light emission control module 16 and the second light emission control module 17 are turned on to enable the driving module 10 to drive the light emitting module 14 to emit light.

In the first initialization phase t5, the initialization unit 131 is turned on in response to the low level of the second scan signal S2 to transmit the first initialization voltage Vini to the first terminal of the coupling module 11, thereby resetting the coupling module 11. The second light emission control module 17 is turned on in response to the low level of the second light emission control signal EM2, and the anode reset module 15 is turned on in response to the high level of the first scan signal S1, thereby transmitting the second initialization voltage Vref to the second terminal S of the driving module 10 and the first terminal of the light emitting module 14. The compensation module 11 is turned on in response to the high level of the fourth scan signal S4, and the data writing unit 132 is turned off in response to the high level of the third scan signal S3. The first light emission control module 16 is turned off in response to the high level of the first light emission control signal EM1.

In the second initialization phase t6, the anode reset module 15 is turned on in response to the high level of the first scan signal S1 to transmit the second initialization voltage Vref to the first terminal of the light emitting module 14, thereby resetting the light emitting module 14.

In the threshold compensation phase t2 of the write frame, the initialization unit 131 is first turned on and then turned off in response to the second scan signal S2. When turned on, it transmits the first initialization voltage Vini to the first terminal of the coupling module 11, thereby resetting the coupling module 11. The second light emission control module 17 is first turned on and then turned off in response to the second light emission control signal EM2, and the anode reset module 15 is turned on in response to the high level of the first scan signal S1. When both the anode reset module 15 and the second light emission control module 17 are turned on, the second initialization voltage Vref is transmitted to the second terminal S of the driving module 10. After the anode reset module 15 is turned on, the resetting of the light emitting module 14 is achieved. The compensation module 12 is turned on in response to the fourth scan signal S4 to connect the control terminal G of the driving module 10 and the first terminal D of the driving module 10. The potential of the first terminal D of the driving module 10 is the voltage provided by the first power supply VDD, and there is a potential difference with the second initialization voltage Vref. The first terminal D of the driving module 10 discharges to the second terminal S of the driving module 10 until the potential of the control terminal of the driving module 10 is VG = Vref + Vth, and the driving module 10 is turned off, completing the compensation of the threshold voltage of the driving module 10. The first light emission control module 16 is turned off in response to the high level of the first light emission control signal EM1, and the data writing unit 132 is first turned off and then turned on in response to the third scan signal S3. When the initialization unit 131 is turned on, the data writing unit 132 is turned off; when the data writing unit 132 is turned on, the initialization unit 131 is turned off. The turn-off time of the second light emission control module 17 is the same as the turn-on time of the data writing unit 132 and the turn-off time of the initialization unit 131.

In the data writing phase t3 of a write frame, the initialization unit 131 is turned off in response to the high level of the second scan signal S2, the second light emission control module 17 is turned off in response to the high level of the second light emission control signal EM2, and the first light emission control module 16 is turned off in response to the high level of the first light emission control signal EM1. The compensation module 12 is first turned on in response to the fourth scan signal S4, and the data writing unit 132 is turned on in response to the low level of the third scan signal S3, to transmit the data voltage Vdata to the first terminal of the coupling module 11. The coupling module 11 couples the voltage jump amount (Vdata-Vini) of the first terminal to the second terminal, and the potential VG of the control terminal G of the driving module 10 is VG=Vref+Vth+(Vdata-Vini)*Cst1/(Cst1+Cst2). Here, Cst1 is the capacitance value of the coupling module 11, and Cst2 is the capacitance value of the storage module 18. Then, the compensation module 12 is turned off in response to the fourth scan signal S4, to store the voltage including the data voltage Vdata at the control terminal G of the driving module 10. Even if the data voltage written by the data writing unit 132 changes in the remaining phases, it does not affect the potential of the control terminal G of the driving module 10, and thus does not affect the light emission brightness. In the data writing phase t3 of a write frame, the anode reset module 15 is turned on in response to the high level of the first scan signal S1, resetting the anode of the light emission module 14.

In the light emission phase t4 of a write frame, the anode reset module 15 is turned off in response to the low level of the first scan signal S1, the compensation module 12 is turned off in response to the low level of the fourth scan signal S4, the data writing unit 132 is turned off in response to the high level of the third scan signal S3, and the initialization unit 131 is turned on in response to the low level of the second scan signal S2. The first light emission control module 16 is turned on in response to the low level of the first light emission control signal EM1, and the second light emission control module 17 is turned on in response to the low level of the second light emission control signal EM2. The driving module 10 generates a driving current I based on the potential of the control terminal G of the driving module 10 to drive the light emission module 14 to emit light. The driving current I=K(VGS-Vth)²=K(((Vdata-Vini)*Cst1/(Cst1+Cst2)))², where K is a proportionality factor.

From the above equation, it can be seen that the driving current is not affected by the threshold voltage Vth of the driving module 10, the voltage of the first power supply VDD, or the voltage of the second power supply VSS, thereby achieving compensation for the threshold voltage, eliminating the effect of voltage drop (IR Drop), and improving display uniformity. From the above, it can be seen that for any write frame, the start time of the second initialization phase t6 is the same as the start time of the threshold compensation phase t2, and the end time of the second initialization phase t6 is later than the end time of the threshold compensation phase t2.

In the black insertion phase t7 of a hold frame, the anode reset module 15 is turned on in response to the high level of the first scan signal S1, achieving reset of the first terminal of the light emission module 14.

In the light emission phase t8 of a hold frame, the first light emission control module 16 is turned on in response to the low level of the first light emission control signal EM1, and the second light emission control module 17 is turned on in response to the low level of the second light emission control signal EM2. The driving module 10 generates a driving current based on the data voltage to drive the light emission module 14 to emit light.

Throughout the entire hold frame F2, the compensation module 12 and the data writing unit 132 are maintained in an off state, and the initialization unit 131 and the second light emission control module 17 are maintained in an on state.

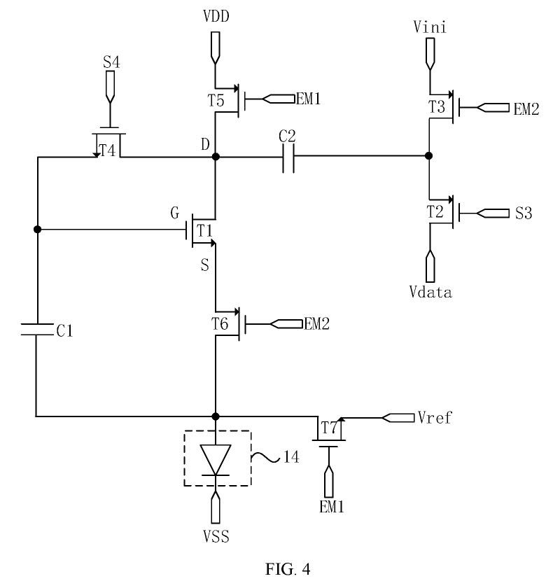

For the pixel circuit shown in FIG. 2, an embodiment of the present application further provides a specific pixel circuit, as shown in FIG. 4, which is a schematic structural diagram of another pixel circuit provided in an embodiment of the present application. Referring to FIGS. 2 and 4, in one embodiment, the driving module 10 includes a first transistor T1, where a first electrode of the first transistor T1 is respectively connected to the second terminal of the first light emission control module 16, the second terminal of the coupling module 11, and the first terminal of the compensation module 12, a second electrode of the first transistor T1 is connected to the first terminal of the second light emission control module 17, and a gate of the first transistor T1 is connected to the second terminal of the compensation module 12 and the storage module 18.

The data writing unit 132 includes a second transistor T2, where a first electrode of the second transistor T2 is connected to a data line for providing the data voltage Vdata, a second electrode of the second transistor T2 is connected to the first terminal of the coupling module 11, and a gate of the second transistor T2 receives the third scan signal S3.

The initialization unit 131 includes a third transistor T3, where a first electrode of the third transistor T3 is connected to a first initialization signal line providing a first initialization voltage Vini, a second electrode of the third transistor T3 is connected to the first terminal of the coupling module 11, and a gate of the third transistor T3 receives the second scan signal S2.

The compensation module 12 includes a fourth transistor T4, where a first electrode of the fourth transistor T4 is respectively connected to the first terminal D of the driving module 10, the second terminal of the coupling module 11, and the second terminal of the first light emission control module 16, a second electrode of the fourth transistor T4 is connected to the control terminal G of the driving module 10, and a gate of the fourth transistor T4 receives the fourth scan signal S4.

The first light emission control module 16 includes a fifth transistor T5, where a first electrode of the fifth transistor T5 is connected to the first power supply VDD, a second electrode of the fifth transistor T5 is respectively connected to the first terminal of the compensation module 12, the first terminal D of the driving module 10, and the second terminal of the coupling module 11, and a gate of the fifth transistor T5 receives the first light emission control signal EM1.

The second light emission control module 17 includes a sixth transistor T6, where a first electrode of the sixth transistor T6 is connected to the second terminal S of the driving module 10, a second electrode of the sixth transistor T6 is connected to the first terminal of the light emission module 14, and a gate of the sixth transistor T6 receives the second light emission control signal EM2.

The anode reset module 15 includes a seventh transistor T7, where a first electrode of the seventh transistor T7 is connected to a second initialization signal line providing a second initialization voltage Vref, a second electrode of the seventh transistor T7 is connected to the first terminal of the light emission module 14, and a gate of the seventh transistor T7 receives the first scan signal S1, and a second terminal of the light emission module 14 is connected to the second power supply VSS.

The coupling module 11 includes a second capacitor C2, a first terminal of the second capacitor C2 is respectively connected to the data writing unit 132 and the initialization unit 131, and a second terminal of the second capacitor C2 is respectively connected to a second terminal of the first light emission control module 16, a first terminal D of the driving module 10, and a first terminal of the compensation module 12.

The storage module 18 includes a first capacitor C1, a first terminal of the first capacitor C1 is connected to a control terminal G of the driving module 10, and a second terminal of the first capacitor C1 is connected to a first terminal of the light emitting module 14.

In this embodiment, the first transistor T1, the fourth transistor T4, and the seventh transistor T7 are all N-type transistors, and the third transistor T3, the second transistor T2, the fifth transistor T5, and the sixth transistor T6 are all P-type transistors. The first light emission control signal EM1 is reused as the first scan signal S1, that is, a gate of the seventh transistor T7 is connected to the first light emission control signal EM1. The second light emission control signal EM2 is reused as the second scan signal S2, that is, a gate of the third transistor T3 is connected to the second light emission control signal EM2. The driving timing of the pixel circuit in FIG. 4 is shown in FIG. 3, and the specific working process is the same as that in FIG. 2, which will not be repeated here.

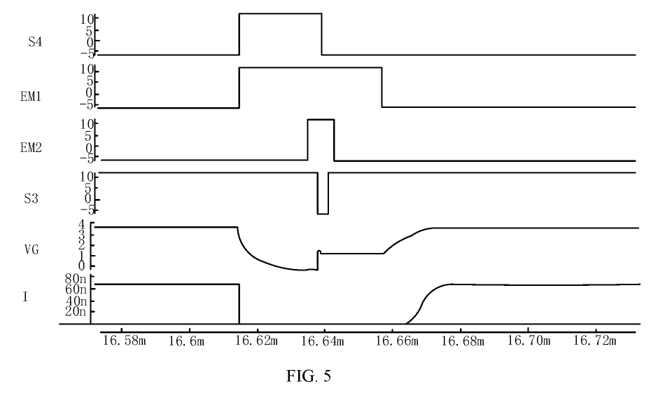

The pixel circuit shown in FIG. 4 is used to drive the light emitting module to emit light, and a simulation is performed to obtain a simulation diagram shown in FIG. 5. FIG. 5 is a simulation waveform diagram of a working process of a pixel circuit provided in an embodiment of the present application. FIG. 5 includes waveform diagrams of a driving current I, a potential VG of the control terminal of the driving module, a third scan signal S3, a first light emission control signal EM1, a second light emission control signal EM2, and a fourth scan signal S4, and the abscissa of each waveform is time in seconds, the ordinate of the driving current I is current in amperes, and the ordinates of the remaining signals are voltage in volts. Referring to FIG. 2, FIGS. 4 and 5, it can be seen that in the threshold compensation phase, the potential of the control terminal G of the driving module 10, i.e., the gate of the first transistor T1, gradually decreases over time to perform threshold voltage compensation.

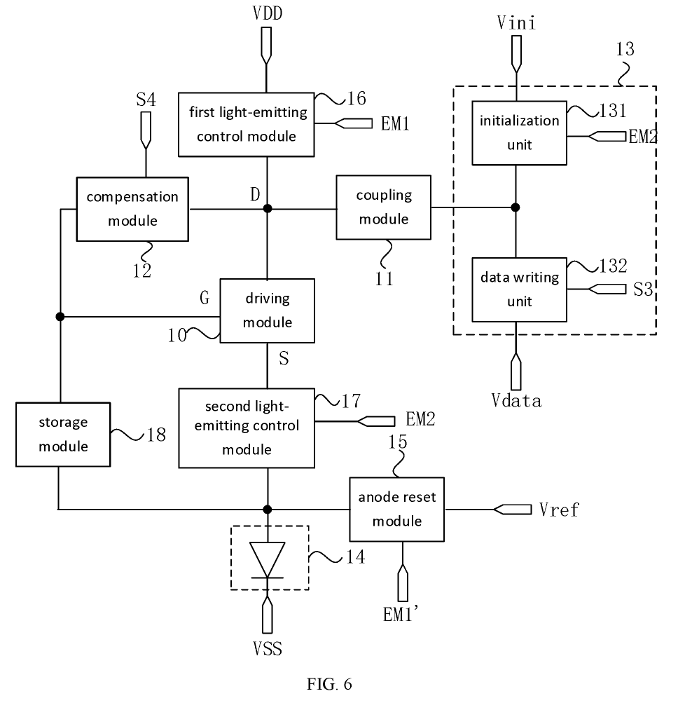

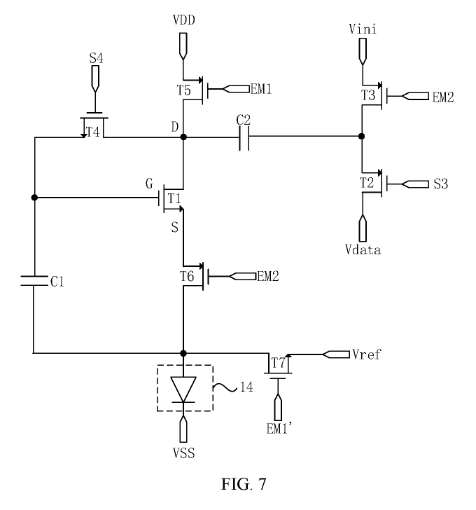

In the pixel circuits shown in FIGS. 2 and 4, the first light emission control signal EM1 is reused as the first scan signal S1 to reduce the number of scan driving circuits, which is beneficial for achieving a narrow bezel of the panel. In another embodiment, the first light emission control signal EM1 and the first scan signal S1 connected to the same pixel circuit may come from shift registers of different stages in the same set of scan driving circuits. In one embodiment, FIG. 6 is a schematic structural diagram of another pixel circuit provided in an embodiment of the present application, and FIG. 7 is a schematic structural diagram of another pixel circuit provided in an embodiment of the present application. FIG. 7 is a specific circuit structure corresponding to FIG. 6. Referring to FIGS. 6 and 7, the type of transistors included in the first light emission control module 16 is opposite to the type of transistors included in the anode reset module 15.

In a display panel corresponding to the pixel circuit, the pixel circuits are arranged in an array.

The first light emission control modules 16 of pixel circuits located in the same row are connected to the same first light emission control signal EM1, and the anode reset modules 15 of pixel circuits located in the same row are connected to the same first scan signal.

In two adjacent rows of pixel circuits, the first light emission control signal EM1' connected to the pixel circuit in the previous row is reused as the first scan signal connected to the pixel circuit in the next row.

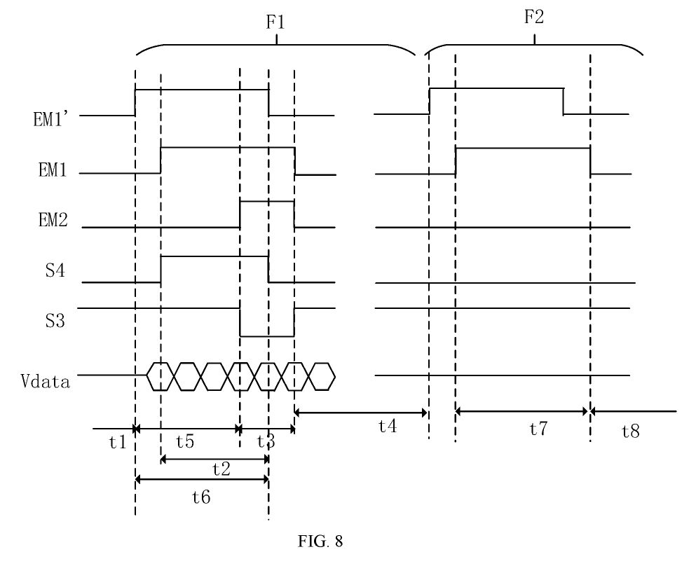

The difference between the pixel circuits shown in FIGS. 6 and 2 is only the signal connected to the control terminal of the anode reset module 15, and the difference between the pixel circuits shown in FIGS. 7 and 4 is only the signal connected to the gate of the seventh transistor T7, and the other structures are the same, which will not be repeated here. Referring to FIGS. 6 and 7, the pixel circuit in FIGS. 6 and 7 is a pixel circuit located in the nth row, then the first scan signal connected to the control terminal of the anode reset module 15 or the first scan signal connected to the gate of the seventh transistor T7 is the first light emission control signal connected to the pixel circuit in the (n-1)th row, i.e., the first light emission control signal EM1' connected to the pixel circuit in the previous row. The display panel includes a scan driving circuit for providing the first light emission control signal EM1, the scan driving circuit includes a plurality of shift registers connected in cascade, a first output terminal of the shift register is connected to the pixel circuit of the corresponding row for outputting the first light emission control signal EM1 to the pixel circuit of the corresponding row, and the first output terminal of the shift register is also connected to the gates of the seventh transistors T7 in the pixel circuit of the next row, thereby realizing that the first scan signal and the first light emission control signal share one set of scan driving circuits, reducing the number of scan driving circuits. FIG. 8 is a driving timing diagram of another pixel circuit provided in an embodiment of the present application, and FIG. 8 is applicable to the pixel circuits shown in FIGS. 6 and 7. Referring to FIGS. 6-8, in this embodiment, a start time of a second initialization phase t6 is earlier than a start time of a threshold compensation phase t2, and an end time of the second initialization phase t6 is the same as an end time of the threshold compensation phase t2; in any write frame, the second initialization phase t6 overlaps with a data writing phase t3, the start time of the second initialization phase t6 is earlier than a start time of the data writing phase t3, and the end time of the second initialization phase t6 is earlier than an end time of the data writing phase. The driving timing shown in FIG. 8 is similar to that in FIG. 3, and the specific driving process is similar to that in FIG. 3, which will not be repeated here. In this embodiment, the first light emission control signal EM1' connected to the pixel circuit in the previous row is reused as the first scan signal connected to the pixel circuit in the next row, providing convenience for different layout designs.

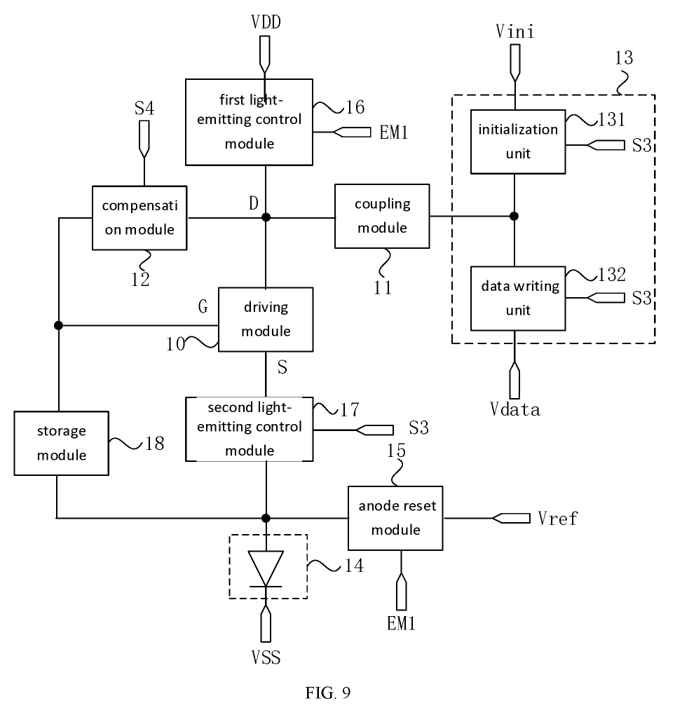

In addition to the pixel circuits shown in FIGS. 2 and 6, or 4 and 7, to further reduce the number of scan driving circuits in the display panel, this embodiment provides a third pixel circuit. FIG. 9 is a schematic structural diagram of another pixel circuit provided in an embodiment of the present application. The difference between FIGS. 9 and 2 lies only in the different signals connected to the control terminal of the initialization unit 131 and the different signals connected to the control terminal of the second emission control module 17. In one embodiment, in the third pixel circuit, the first emission control signal EM1 is reused as the first scan signal, the type of transistor included in the data writing unit 132 is opposite to the type of transistor included in the initialization unit 131, and the third scan signal S3 is reused as the second scan signal. The type of transistor included in the second emission control module 17 is the same as the type of transistor included in the initialization unit 1321, and the second scan signal is reused as the second emission control signal. That is, the control terminals of the second emission control module 17, the data writing unit 132, and the initialization unit 131 are connected to the same signal, the third scan signal S3 is reused as the second emission control signal EM2 and the second scan signal S2, and the control terminals of the second emission control module 17, the initialization unit 131, and the data writing unit 132 are all connected to the third scan signal S3, to save the number of scan driving circuits.

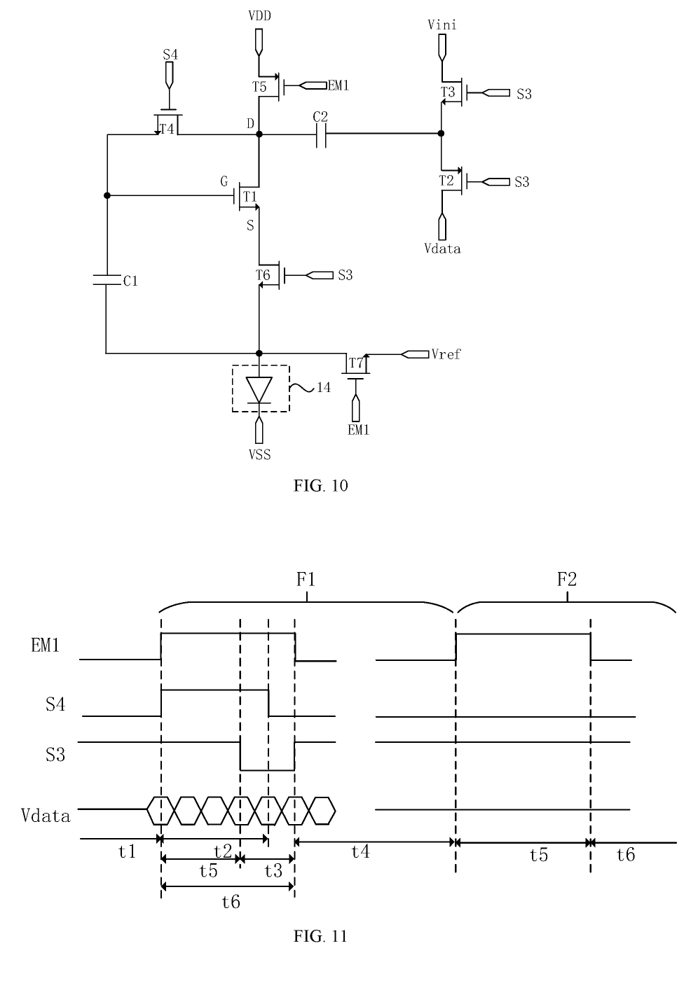

FIG. 10 is a schematic structural diagram of another pixel circuit provided in an embodiment of the present application, and FIG. 10 is a specific pixel circuit structure corresponding to FIG. 9. In FIG. 9, the transistors included in the driving module 10, the compensation module 12, the second emission control module 17, the anode reset module 15, and the initialization unit 131 are all N-type transistors, further oxide transistors, and the transistors included in the first emission control module 16 and the data writing unit 132 are all P-type transistors, further low-temperature polysilicon transistors. In one embodiment, in FIG. 10, the first transistor T1, the sixth transistor T6, the seventh transistor T7, the fourth transistor T4, and the third transistor T3 are all N-type transistors, further oxide transistors, and the fifth transistor T5 and the second transistor T2 are both P-type transistors, further low-temperature polysilicon transistors. FIG. 11 is a driving timing diagram of another pixel circuit provided in an embodiment of the present application. Referring to FIG. 11, in any write frame F1, the start time of the first initialization phase t5 is the same as the start time of the threshold compensation phase t2, the end time of the first initialization phase t5 is earlier than the end time of the threshold compensation phase t2, and the second initialization phase t6 includes the first initialization phase t5 and the data writing phase t3, that is, the start time of the second initialization phase t6 is the same as the start time of the first initialization phase t5, earlier than the start time of the data writing phase t3, and the end time of the second initialization phase t6 is the same as the end time of the data writing phase t3. The start time of the second initialization phase t6 is the same as the start time of the threshold compensation phase t2, and the end time of the second initialization phase t6 is later than the end time of the threshold compensation phase t2. The working process of the pixel circuit in FIG. 11 is similar to that in FIG. 3, and will not be repeated here.

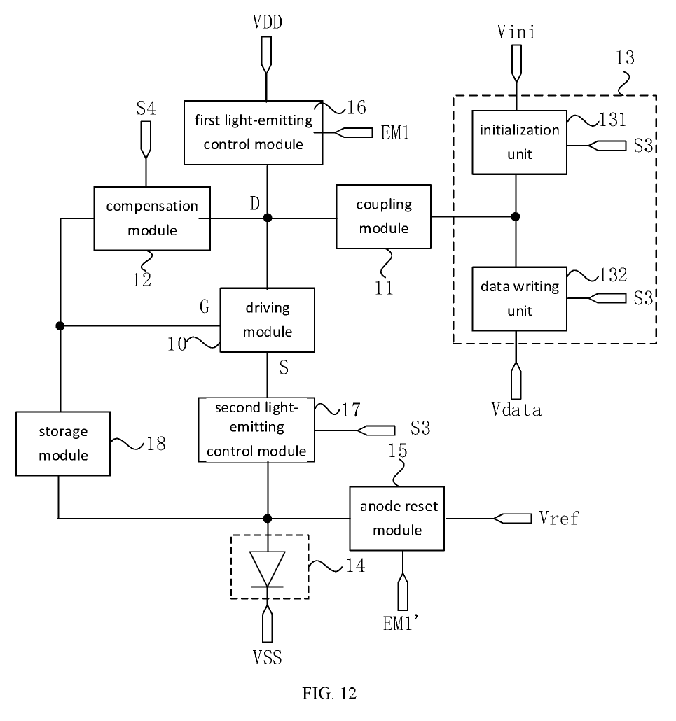

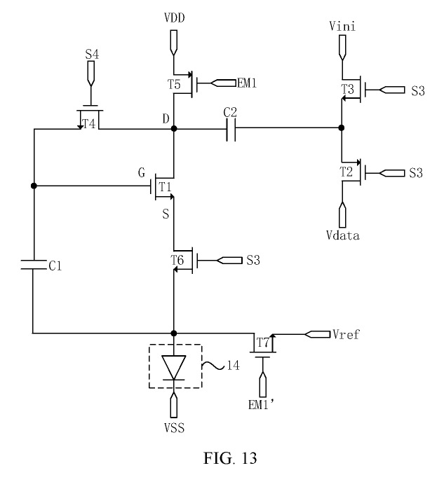

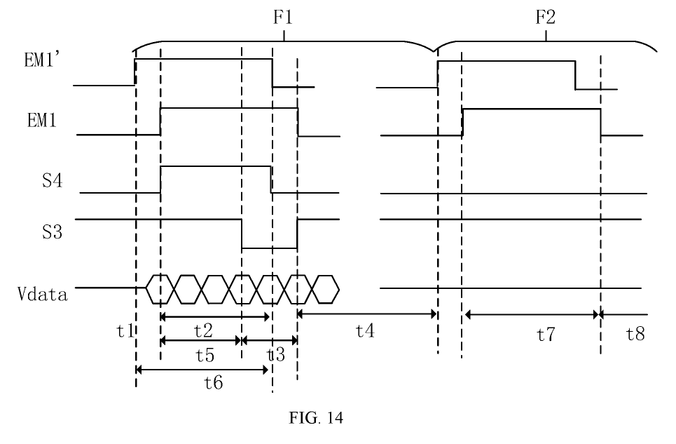

The third pixel circuit provided in this embodiment, that is, the pixel circuit shown in FIGS. 9 or 10, only requires three sets of scan driving circuits to respectively provide the first emission control signal EM1, the fourth scan signal S4, and the third scan signal S3, and the number of required scan driving circuits is small, which can achieve narrower left and right bezels of the panel. On the basis of the third pixel circuit, the embodiment of the present application also provides a fourth pixel circuit. FIG. 12 is a schematic structural diagram of another pixel circuit provided in an embodiment of the present application, FIG. 13 is a schematic structural diagram of another pixel circuit provided in an embodiment of the present application, and FIG. 13 is a specific circuit structure corresponding to FIG. 12. The difference between FIGS. 12 and 9 lies in the different signals connected to the anode reset module 15. In one embodiment, in two adjacent rows of pixel circuits, the first emission control signal EM1' connected to the previous row of pixel circuits is reused as the first scan signal connected to the next row of pixel circuits, that is, the control terminal of the anode reset module 15 is connected to the first emission control signal EM1' connected to the previous row of pixel circuits. The difference between FIGS. 13 and 10 lies only in that the signal connected to the gate of the seventh transistor T7 is the first emission control signal EM1' connected to the previous row of pixel circuits. FIG. 14 is a driving timing diagram of another pixel circuit provided in an embodiment of the present application. The driving timing shown in FIG. 14 is applicable to the pixel circuits shown in FIGS. 12 and 13. In this embodiment, for any write frame, the start time of the first initialization phase t5 is the same as the start time of the threshold compensation phase t2, and the end time of the first initialization phase t5 is earlier than the end time of the threshold compensation phase t2. There is no overlap between the first initialization phase t5 and the data writing phase t3. The start time of the second initialization phase t6 is earlier than the start time of the threshold compensation phase t2, and the end time of the second initialization phase t6 is the same as the end time of the threshold compensation phase t2. In the fourth pixel circuit, the signal connected to the control terminal of the first emission control module 16 and the signal connected to the control terminal of the anode reset module 15 are provided by one set of scan driving circuits, the signals connected to the control terminals of the initialization unit 131, the data writing unit 132, and the second emission control module 17 are provided by one set of scan driving circuits, and the signal connected to the control terminal of the compensation module 12 is provided by one set of scan driving circuits, requiring only three sets of scan driving circuits, simplifying the structure of the display panel and facilitating the realization of a narrow bezel of the panel. In this embodiment, the first emission control signal EM1' connected to the previous row of pixel circuits is reused as the first scan signal connected to the next row of pixel circuits, providing convenience for different layout designs.

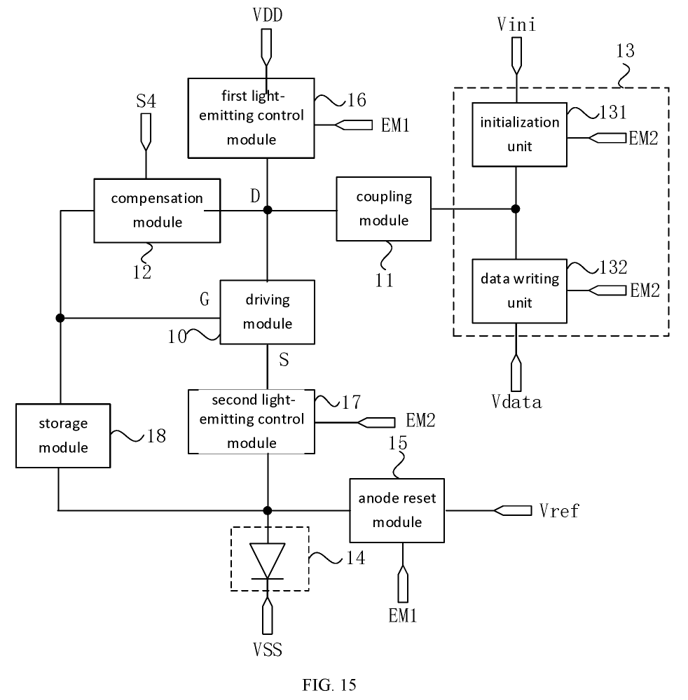

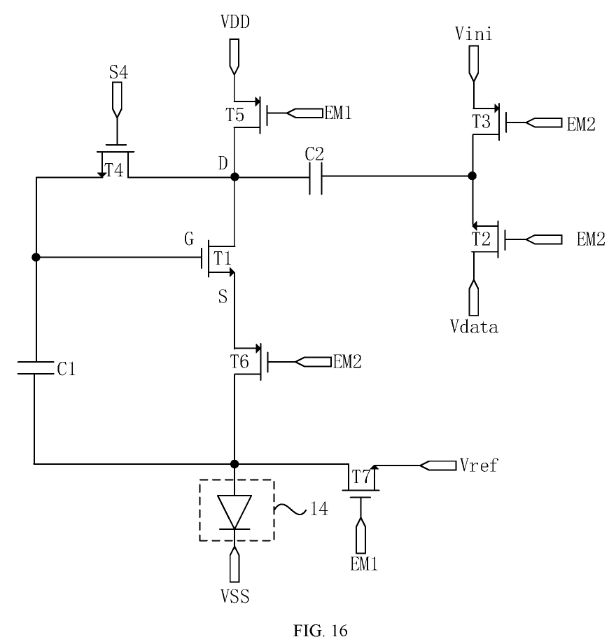

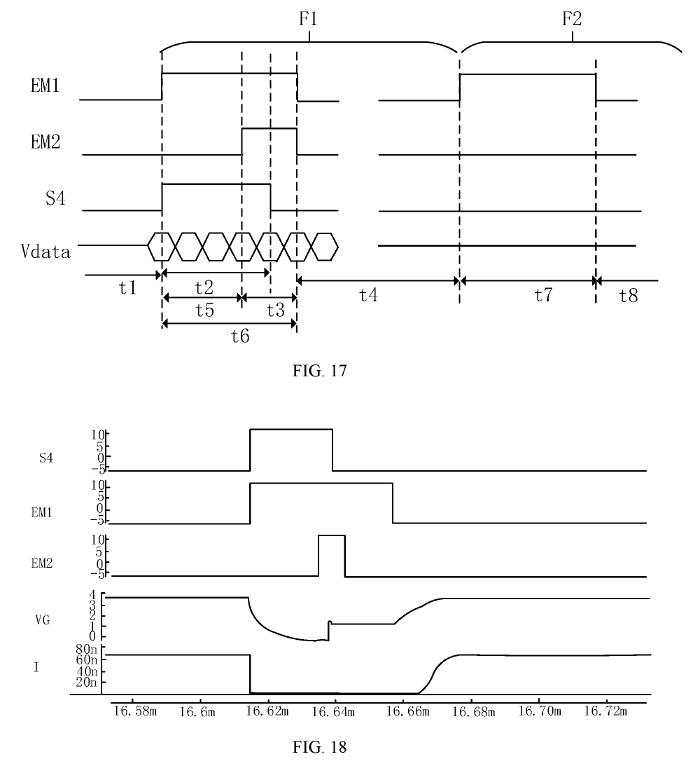

FIG. 15 is a schematic structural diagram of another pixel circuit provided in an embodiment of the present application. Referring to FIG. 15, in FIG. 15, the transistor type included in the second light emission control module 17 is the same as the transistor type included in the initialization unit 131, and the transistor type included in the data writing unit 132 is opposite to the transistor type included in the initialization unit 131. Further, the transistor included in the initialization unit 131 is a P-type transistor, the transistor included in the second light emission control module 17 is a P-type transistor, the transistor included in the data writing unit 132 is an N-type transistor, the transistor included in the compensation module 12 is an N-type transistor, the transistor included in the driving module is an N-type transistor, the transistor included in the anode reset module 15 is an N-type transistor, and the transistor included in the first light emission control module 16 is a P-type transistor. Further, the transistor included in the data writing unit 132 is an oxide transistor, the transistor included in the initialization unit 131 is a low-temperature polysilicon transistor, and the transistor included in the second light emission control module 17 is a low-temperature polysilicon transistor. The difference between the pixel circuit shown in FIG. 15 and the pixel circuit shown in FIG. 2 is that the transistor included in the data writing unit 132 in FIG. 15 is an N-type transistor, and the control terminal of the data writing unit 132, the control terminal of the initialization unit 131, and the control terminal of the second light emission control module 17 in FIG. 15 are all connected to the second light emission control signal EM2. FIG. 16 is a schematic structural diagram of another pixel circuit provided in an embodiment of the present application. FIG. 16 is a specific pixel circuit structure corresponding to FIG. 15. The difference between FIGS. 16 and 4 is only that the gate of the second transistor T2 is connected to the second light emission control signal EM2. FIG. 17 is a driving timing diagram of another pixel circuit provided in an embodiment of the present application. Referring to FIGS. 15 - 17, in any write frame F1, the start time of the first initialization phase t5 is the same as the start time of the threshold compensation phase t2, the end time of the first initialization phase t5 is earlier than the end time of the threshold compensation phase t2, and the second initialization phase t6 includes the first initialization phase t5 and the data writing phase t3, that is, the start time of the second initialization phase t6 is the same as the start time of the first initialization phase t5 and is earlier than the start time of the data writing phase t3, and the end time of the second initialization phase t6 is the same as the end time of the data writing phase t3. The start time of the second initialization phase t6 is the same as the start time of the threshold compensation phase t2, and the end time of the second initialization phase t6 is later than the end time of the threshold compensation phase t2.

The driving process shown in FIG. 17 is similar to the driving process shown in FIG. 3, and will not be repeated here. Using the pixel circuit shown in FIGS. 15 or 16 for simulation, a waveform diagram of the working process of the pixel circuit shown in FIG. 18 is obtained. FIG. 18 is a simulation waveform diagram of the working process of another pixel circuit provided in an embodiment of the present application. The simulation waveform diagram shown in FIG. 18 is similar to FIG. 5, and will not be repeated here.

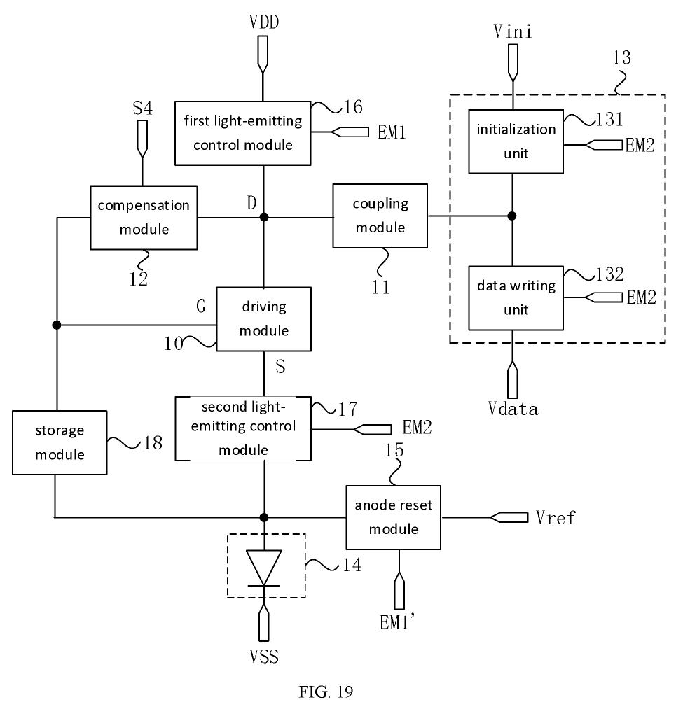

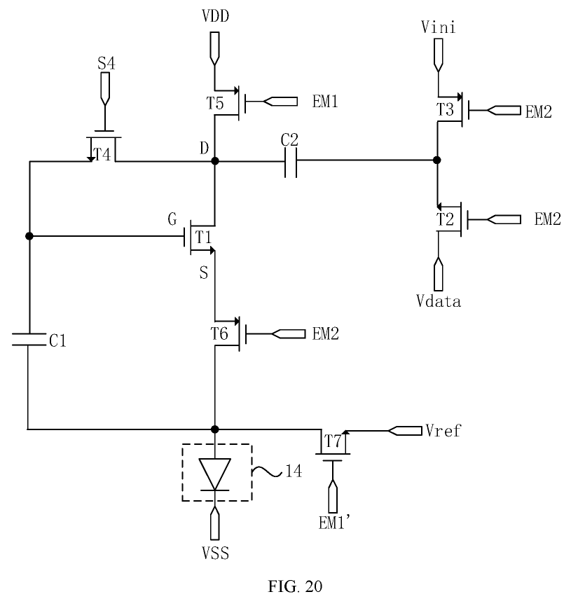

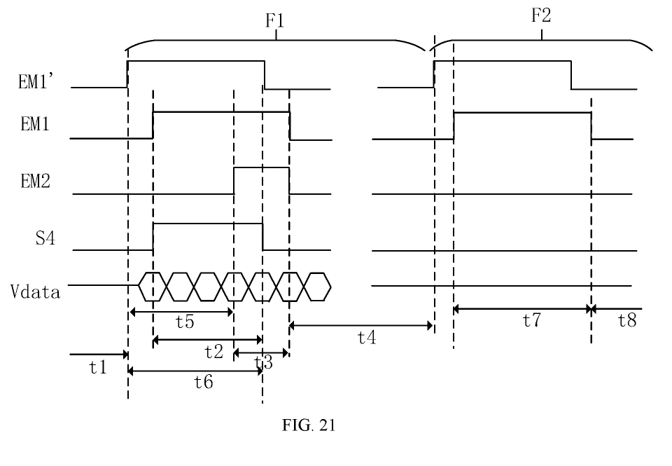

Based on the pixel circuit shown in FIG. 15, another pixel circuit similar to FIG. 15 can also be provided. FIG. 19 is a schematic structural diagram of another pixel circuit provided in an embodiment of the present application. The difference between FIG. 19 and the pixel circuit shown in FIG. 15 is that the signal connected to the control terminal of the anode reset module 15 is different. In FIG. 19, in two adjacent rows of pixel circuits, the first light emission control signal EM1' connected to the previous row of pixel circuits is reused as the first scan signal connected to the next row of pixel circuits, that is, the signal connected to the control terminal of the anode reset module 15 is the first light emission control signal EM1' connected to the previous row of pixel circuits. FIG. 20 is a schematic structural diagram of another pixel circuit provided in an embodiment of the present application. FIG. 20 is a specific structure of the pixel circuit corresponding to FIG. 19. The difference between FIGS. 20 and 16 is that the signal connected to the gate of the seventh transistor T7 is the first light emission control signal EM1' connected to the previous row of pixel circuits. FIG. 21 is a driving timing diagram of another pixel circuit provided in an embodiment of the present application. In this embodiment, in any write frame F1, the start time of the second initialization phase t6 is earlier than the start time of the threshold compensation phase t2, and the end time of the second initialization phase t6 is the same as the end time of the threshold compensation phase t2; the second initialization phase t6 overlaps with the data writing phase t3, the start time of the second initialization phase t6 is earlier than the start time of the data writing phase t3, and the end time of the second initialization phase t6 is earlier than the end time of the data writing phase t3. For any write frame, the threshold compensation phase t2 and the data writing phase t3 partially overlap; the start time of the threshold compensation phase t2 is earlier than the start time of the data writing phase t3, the end time of the threshold compensation phase t2 is earlier than the end time of the data writing phase t3, the threshold compensation phase t2 and the first initialization phase t5 partially overlap, and the end time of the threshold compensation phase t2 is later than the end time of the first initialization phase t6.

In this embodiment, the first light emission control signal EM1' connected to the previous row of pixel circuits is reused as the first scan signal connected to the next row of pixel circuits, providing convenience for different layout designs.

Whether it is the pixel circuit shown in FIG. 16 or the pixel circuit shown in FIG. 20, three sets of scan driving circuits are used to provide signals connected to the gates of each transistor, and the number of scan driving circuits is relatively small, which is beneficial to achieving a narrow bezel of the panel. At the same time, compared to the pixel circuit shown in FIGS. 10 or 13, the pixel circuit in FIGS. 16 or 20 includes four N-type transistors and three P-type transistors, and the N-type transistors and P-type transistors are formed on different layers, and the quantity ratio of the two types of transistors is more balanced, which can reduce the occupation of lateral area and is beneficial to achieving higher pixel density.

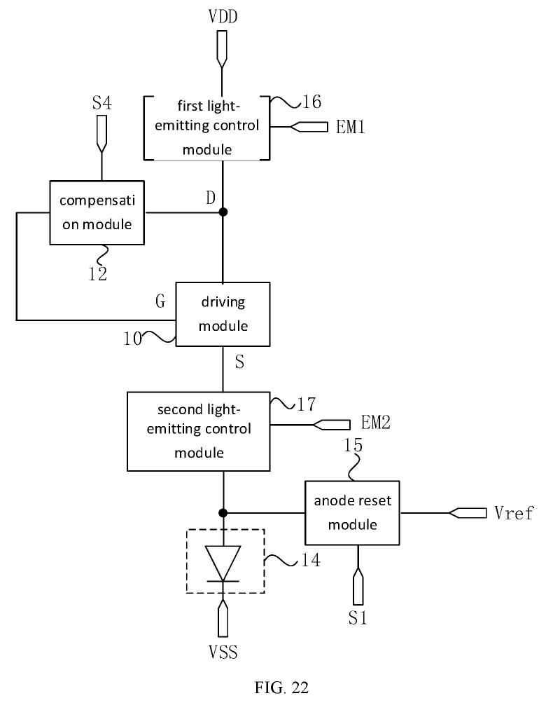

An embodiment of the present application also provides a pixel circuit. FIG. 22 is a schematic structural diagram of another pixel circuit provided in an embodiment of the present application. Referring to FIG. 22, the pixel circuit includes: a driving module 10, a compensation module 12, a first light emission control module 16, a second light emission control module 17, an anode reset module 15, and a light emission module 14.

A first terminal of the compensation module 12 is connected to a first terminal D of the driving module 10, and a second terminal of the compensation module 12 is connected to a control terminal G of the driving module 10. The compensation module 12 is configured to transmit threshold voltage information of the driving module 10 to the control terminal G of the driving module 10 based on a voltage at the first terminal D of the driving module 10 after discharge through the driving module 10.

A first light emission control module 16, the driving module 10, a second light emission control module 17, and a light emitting module 14 are sequentially connected in series between a first power supply VDD and a second power supply VSS. The first light emission control module 16 is configured to be turned on in response to a first light emission control signal EM1.

An anode reset module 15 is configured to provide a second initialization voltage Vref to a first terminal of the light emitting module 14 in response to a first scan signal S1.

A type of a transistor included in the first light emission control module 16 is opposite to a type of a transistor included in the anode reset module 15.

The first light emission control signal EM1 is reused as the first scan signal S1, or, in a display panel corresponding to the pixel circuit, pixel circuits are arranged in an array, the first light emission control modules 16 of pixel circuits in a same row are connected to a same first light emission control signal EM1, the anode reset modules 15 of the pixel circuits in the same row are connected to a same first scan signal S1, and among two adjacent rows of pixel circuits, the first light emission control signal connected to the pixel circuits in a previous row is reused as the first scan signal S1 connected to the pixel circuits in a next row.

In this embodiment, during a threshold compensation phase of a write frame, the first terminal D of the driving module 10 is discharged through the second light emission control module 17 and the anode reset module 15 until a potential difference between the control terminal and a second terminal S of the driving module 10 equals a threshold voltage of the driving module 10, at which point the discharge ends, completing threshold compensation. The anode reset module 15 is configured to be turned on during a second initialization phase to provide the second initialization voltage Vref to the first terminal of the light emitting module 14, i.e., the anode of the light emitting module 14, thereby achieving anode reset. During a light emission phase of the write frame, the first light emission control module 16 and the second light emission control module 17 are turned on, and the driving module 10 drives the light emitting module 14 to emit light based on a generated driving current.

In this embodiment, the first light emission control signal EM1 is reused as the first scan signal S1, or the first light emission control signal connected to the pixel circuits in the previous row is reused as the first scan signal S1 connected to the pixel circuits in the next row, and the signal connected to the control terminal of the first light emission control module 16 and the signal connected to the control terminal of the anode reset module 15 are generated by a same scan driving circuit, thereby reducing the number of scan driving circuits, which is beneficial for achieving a narrow bezel of the panel. Furthermore, the reuse of the first light emission control signal connected to the pixel circuits in the previous row as the first scan signal S1 connected to the pixel circuits in the next row makes the layout design more convenient.

In one embodiment, the pixel circuit further includes a voltage writing module and a coupling module, with a structure identical to that in FIG. 2, and reference can be made to FIG. 2.

A first terminal of the coupling module 11 is connected to the voltage writing module 13, and a second terminal of the coupling module 11 is connected to the first terminal D of the driving module 10. The voltage writing module 13 is configured to time-divisionally transmit a first initialization voltage Vini and a data voltage Vdata to the first terminal of the coupling module 11.

The coupling module 11 is configured to couple a voltage containing the data voltage Vdata to the control terminal G of the driving module 10.

Further, the voltage writing module 13 includes an initialization unit 131 and a data writing unit 132. One display cycle of the pixel circuit includes a write frame and a hold frame.

The initialization unit 131 is connected to the first terminal of the coupling module 11 and is configured to provide the first initialization voltage Vini to the first terminal of the coupling module 11 in response to a second scan signal S2 during a first initialization phase of the write frame.

The data writing unit 132 is connected to the first terminal of the coupling module 11 and is configured to provide the data voltage Vdata to the first terminal of the coupling module 11 in response to a third scan signal S3 during a data writing phase of the write frame.

The coupling module 11 is configured to transmit a voltage containing the data voltage Vdata to the control terminal of the driving module 10 through the turned-on compensation module 12.

The compensation module 12 is configured to be turned on in response to a fourth scan signal S4 during the threshold compensation phase of the write frame, to transmit the threshold voltage information of the driving module 10 to the control terminal of the driving module 10 based on a voltage at the first terminal D of the driving module 10 after discharge through the driving module 10, the second light emission control module 17, and the anode reset module 15.

The operating principle of the pixel circuit in this embodiment is similar to that in FIG. 2, and will not be repeated here.

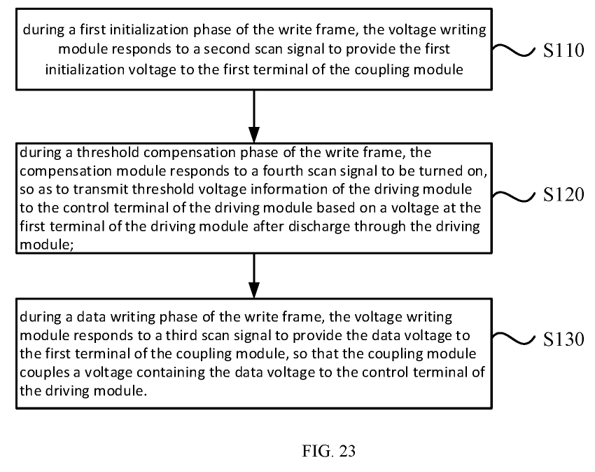

An embodiment of the present application also provides a driving method for a pixel circuit. FIG. 23 is a flowchart of a driving method for a pixel circuit according to an embodiment of the present application. One display cycle of the pixel circuit at least includes a write frame. Referring to FIGS. 2 and 23, the method includes:

S110: During a first initialization phase of the write frame, the voltage writing module 13 provides the first initialization voltage Vini to the first terminal of the coupling module 11 in response to the second scan signal S2.

The voltage writing module 13 is a switching module. The second scan signal S2 controls whether the first terminal of the coupling module 11 is connected to the first initialization voltage Vini. During the first initialization phase of the write frame, the second scan signal controls the voltage writing module 13 to connect the second terminal of the coupling module 11 to the first initialization voltage Vini, thereby providing the first initialization voltage Vini to the first terminal of the coupling module 11.

S120: During the threshold compensation phase of the write frame, the compensation module 12 is turned on in response to the fourth scan signal S4, to transmit the threshold voltage information of the driving module to the control terminal G of the driving module 10 based on a voltage at the first terminal D of the driving module 10 after discharge through the driving module 10.

During the threshold compensation phase of the write frame, a potential difference exists between the first terminal D and the second terminal S of the driving module 10, so the first terminal D discharges to the second terminal S to reduce the potential of the control terminal G of the driving module 10 until the potential difference between the control terminal and the second terminal equals the threshold voltage of the driving module 10, at which point the threshold voltage compensation ends.

S130: In the data writing phase of a write frame, the voltage writing module 13 provides the data voltage Vdata to the first terminal of the coupling module 11 in response to the third scan signal S3, and the coupling module 11 couples the voltage containing the data voltage Vdata to the control terminal G of the driving module 10.

The voltage writing module 13 is a switching module, and the third scan signal S3 controls whether the first terminal of the coupling module 11 is connected to the data voltage Vdata. In the data writing phase of the write frame, the third scan signal S3 controls the voltage writing module 13 to connect the second terminal of the coupling module 11 to the data voltage Vdata, thereby providing the data voltage Vdata to the first terminal of the coupling module 11, and then coupling the voltage containing the data voltage Vdata to the control terminal of the driving module 10 through the coupling module and the compensation module.

In one embodiment of the present application, the threshold voltage of the driving module is compensated by the compensation module to avoid the influence of threshold voltage drift on display uniformity. The data voltage written by the voltage writing module is coupled to the control terminal of the driving module through the coupling module via the compensation module, thereby realizing the writing of the data voltage and the driving module subsequently generates a driving current to drive the light-emitting module to emit light based on the data voltage. The transistors included in the driving module and the compensation module are all oxide transistors, which have a small leakage current in the off state. Since the compensation module is connected to the control terminal of the driving module, the leakage current of the compensation module in the off state is small, resulting in a small potential change at the control terminal of the driving module, thereby improving display uniformity. Among the at least two transistors included in the voltage writing module, at least one transistor is a low-temperature polysilicon transistor, which has high mobility and fast switching speed, improving display reliability. Moreover, the low-temperature polysilicon transistor does not require a large driving voltage, which is beneficial for reducing screen power consumption. The pixel circuit in this embodiment includes both oxide transistors and low-temperature polysilicon transistors, which can balance display uniformity and low power consumption of the screen.

In one embodiment, the pixel circuit further includes an anode reset module, a first light-emitting control module, and a second light-emitting control module, and the driving method of the pixel circuit further includes:
in the second initialization phase of the write frame, the anode reset module is turned on in response to the first scan signal to provide the second initialization voltage to the first terminal of the light-emitting module;
in the light-emitting phase of the write frame, the first light-emitting control module is turned on in response to the first light-emitting control signal, and the second light-emitting control module is turned on in response to the second light-emitting control signal, and the driving module generates a driving current based on the data voltage to drive the light-emitting module to emit light.

In the write frame, the first initialization phase and the data writing phase are not performed simultaneously, and the first initialization phase is earlier than the data writing phase;

for any write frame, the threshold compensation phase and the data writing phase partially overlap;

the start time of the threshold compensation phase is earlier than the start time of the data writing phase, and the end time of the threshold compensation phase is earlier than the end time of the data writing phase;

for any write frame, the threshold compensation phase and the first initialization phase partially overlap, and the end time of the threshold compensation phase is later than the end time of the first initialization phase;

for any write frame, the second initialization phase and the threshold compensation phase partially overlap, the start time of the second initialization phase is the same as the start time of the threshold compensation phase, and the end time of the second initialization phase is later than the end time of the threshold compensation phase, or the start time of the second initialization phase is earlier than the start time of the threshold compensation phase, and the end time of the second initialization phase is the same as the end time of the threshold compensation phase. Various forms of processes shown above can be used, with steps reordered, added, or deleted. For example, the steps described in the present application can be performed in parallel, sequentially, or in a different order, as long as the desired results of the embodiments of the present application can be achieved, and no limitation is imposed herein.

The above specific implementations do not constitute a limitation on the scope of protection of the present application. It should be understood that various modifications, combinations, sub-combinations, and substitutions can be made according to design requirements and other factors. Any modifications, equivalent substitutions, and improvements made within the spirit and principle of the present application shall be included within the scope of protection of the present application.

What is claimed is:

1. A pixel circuit comprising: a driving module, a coupling module, a compensation module, and a voltage writing module, wherein
a first terminal of the compensation module is connected to a first terminal of the driving module, a second terminal of the compensation module is connected to a control terminal of the driving module, and the compensation module is configured to transmit threshold voltage information of the driving module to the control terminal of the driving module, the threshold voltage of the driving module is formed after the driving module performs discharging;
a first terminal of the coupling module is connected to the voltage writing module, a second terminal of the coupling module is connected to the first terminal of the driving module, and the voltage writing module is configured to time-divisionally transmit a first initialization voltage and a data voltage to the first terminal of the coupling module;
the coupling module is configured to couple a voltage containing the data voltage to the control terminal of the driving module;
transistors included in the driving module and transistors included in the compensation module are all oxide transistors, the voltage writing module includes at least one transistor, and at least one transistor in the voltage writing module is a low-temperature polysilicon transistor.

2. The pixel circuit according to claim 1, wherein a display cycle of the pixel circuit includes a write frame and a hold frame, the pixel circuit further includes a light-emitting module and an anode reset module, the anode reset module is connected to a first terminal of the light-emitting module, and is configured to, in a second initialization phase of the write frame , provide a second initialization voltage to the first terminal of the light-emitting module in response to a first scan signal.

3. The pixel circuit according to claim 2, wherein a turn-on frequency of the anode reset module is greater than a turn-on frequency of the compensation module;
the anode reset module is further configured to, in a second initialization phase of a hold frame, in response to the first scan signal, provide the second initialization voltage to the first terminal of the light-emitting module;
the compensation module is configured to be turned off in the hold frame;
in the write frame and the hold frame, the turn-on frequency of the anode reset module is the same.

4. The pixel circuit according to claim 2, wherein a display period of the pixel circuit comprises a write frame and a hold frame, and the pixel circuit further comprises a first light-emitting control module and a second light-emitting control module;
a first terminal of the first light-emitting control module is connected to a first power supply, a second terminal of the first light-emitting control module is connected to a first terminal of the driving module, a first terminal of the second light-emitting control module is connected to a second terminal of the driving module, a second terminal of the second light-emitting control module is connected to a first terminal of the light-emitting module, the first light-emitting control module is configured to be turned on in response to a first light-emitting control signal in both a light-emitting phase of the write frame and a light-emitting phase of the hold frame, and the second light-emitting control module is configured to be turned on in response to a second light-emitting control signal in both the light-emitting phase of the write frame and the light-emitting phase of the hold frame;
the hold frame comprises a light-emitting phase and a black insertion phase, and in the black insertion phase, the first light-emitting control module is turned off in response to the first light-emitting control signal, and the second light-emitting control module is turned on in response to the second light-emitting control signal.

5. The pixel circuit according to claim 4, wherein the voltage writing module comprises an initialization unit and a data writing unit;
the initialization unit is connected to a first terminal of the coupling module, and is configured to, in a first initialization phase of the write frame, in response to a second scan signal, provide the first initialization voltage to the first terminal of the coupling module;
the data writing unit is connected to the first terminal of the coupling module, and is configured to, in a data writing phase of the write frame, in response to a third scan signal, provide the data voltage to the first terminal of the coupling module;
the coupling module is configured to transmit the data voltage to the control terminal of the driving module via the turned-on compensation module;
in the write frame, the first initialization phase and the data writing phase are not performed simultaneously, and the first initialization phase is earlier than the data writing phase;
the compensation module is configured to be turned on in a threshold compensation phase of the write frame in response to a fourth scan signal, to transmit threshold voltage information of the driving module to the control terminal of the driving module, the threshold voltage of the driving module is generated in a path formed by the first terminal of the driving module, the driving module, the second light emission control module and the anode reset module.

6. The pixel circuit according to claim 5, wherein for any write frame, the threshold compensation phase and the data writing phase partially overlap;
a start time of the threshold compensation phase is earlier than a start time of the data writing phase, and an end time of the threshold compensation phase is earlier than an end time of the data writing phase;
for any write frame, the threshold compensation phase and the first initialization phase partially overlap, and the end time of the threshold compensation phase is later than an end time of the first initialization phase;
for any write frame, the second initialization phase and the threshold compensation phase partially overlap, and a start time of the second initialization phase is the same as the start time of the threshold compensation phase, and an end time of the second initialization phase is later than the end time of the threshold compensation phase, or, the start time of the second initialization phase is earlier than the start time of the threshold compensation phase, and the end time of the second initialization phase is the same as the end time of the threshold compensation phase.

7. The pixel circuit according to claim 6, wherein the compensation module is further configured to be turned on first and then turned off in the data writing phase of the write frame in response to the fourth scan signal, to transmit a voltage containing the data voltage to the control terminal of the driving module;
in the data writing phase of any write frame, a turn-on duration of the compensation module is equal to a turn-off duration of the compensation module.

8. The pixel circuit according to claim 6, wherein a type of a transistor included in the first light-emitting control module is opposite to a type of a transistor included in the anode reset module, and the first light-emitting control signal is reused as the first scan signal;
for any write frame, the start time of the second initialization phase is the same as the start time of the threshold compensation phase, and the end time of the second initialization phase is later than the end time of the threshold compensation phase.

9. The pixel circuit according to claim 6, wherein a type of a transistor included in the first light-emitting control module is opposite to a type of a transistor included in the anode reset module;
in a display panel corresponding to the pixel circuit, pixel circuits are arranged in an array;
the first light-emitting control modules of pixel circuits in a same row receive the same first light-emitting control signal, and the anode reset modules of pixel circuits in the same row are receive the same first scan signal;
among two adjacent rows of pixel circuits, the first light emission control signal of the upper row is reused as the first scan signal of the lower row;
in any write frame, the start time of the second initialization phase is earlier than the start time of the threshold compensation phase, and the end time of the second initialization phase is the same as the end time of the threshold compensation phase;
in any write frame, the second initialization phase overlaps with the data writing phase, the start time of the second initialization phase is earlier than the start time of the data writing phase, and the end time of the second initialization phase is earlier than the end time of the data writing phase.

10. The pixel circuit according to claim 8, wherein a transistor type comprised in the second emission control module is identical to a transistor type comprised in the initialization unit, and the second emission control signal is multiplexed as the second scan signal.

11. The pixel circuit according to claim 8, wherein a transistor type comprised in the data writing unit is opposite to a transistor type comprised in the initialization unit, and the third scan signal is multiplexed as the second scan signal.

12. The pixel circuit according to claim 11, wherein a transistor type comprised in the second emission control module is identical to a transistor type comprised in the initialization unit, and the second scan signal is multiplexed as the second emission control signal.

13. The pixel circuit according to claim 12, wherein the transistor comprised in the data writing unit is a P-type transistor, the transistor comprised in the initialization unit is an N-type transistor, and the transistor comprised in the second emission control module is an N-type transistor;
the transistor comprised in the data writing unit is a low-temperature polysilicon transistor, the transistor comprised in the initialization unit is an oxide transistor, and the transistor comprised in the second emission control module is an oxide transistor.

14. The pixel circuit according to claim 12, wherein the transistor comprised in the data writing unit is an N-type transistor, the transistor comprised in the initialization unit is a P-type transistor, and the transistor comprised in the second emission control module is a P-type transistor;
the transistor comprised in the data writing unit is an oxide transistor, the transistor comprised in the initialization unit is a low-temperature polysilicon transistor, and the transistor comprised in the second emission control module is a low-temperature polysilicon transistor.

15. The pixel circuit according to claim 4, wherein the pixel circuit further comprises a storage module, the storage module being connected between a control terminal of the driving module and a first terminal of the light-emitting module;
the storage module comprises a first capacitor, a first terminal of the first capacitor being connected to the control terminal of the driving module, and a second terminal of the first capacitor being connected to the first terminal of the light-emitting module.

16. The pixel circuit according to claim 5, the driving module comprises a first transistor, a first electrode of the first transistor being respectively connected to a second terminal of the first emission control module, a second terminal of the coupling module, and a first terminal of the compensation module, a second electrode of the first transistor being connected to a first terminal of the second emission control module, and a gate of the first transistor being connected to a second terminal of the compensation module;
the data writing unit comprises a second transistor, a first electrode of the second transistor being connected to a data line for providing a data voltage, a second electrode of the second transistor being connected to a first terminal of the coupling module, and a gate of the second transistor receiving the third scan signal;
the initialization unit comprises a third transistor, a first electrode of the third transistor being connected to a first initialization signal line providing the first initialization voltage, a second electrode of the third transistor being connected to the first terminal of the coupling module, and a gate of the third transistor receiving the second scan signal;
the compensation module comprises a fourth transistor, a first electrode of the fourth transistor being respectively connected to the first terminal of the driving module, the second terminal of the coupling module, and the second terminal of the first emission control module, a second electrode of the fourth transistor being connected to the control terminal of the driving module, and a gate of the fourth transistor receiving the fourth scan signal;
the first emission control module comprises a fifth transistor, a first electrode of the fifth transistor being connected to the first power supply, a second electrode of the fifth transistor being respectively connected to the first terminal of the compensation module, the first terminal of the driving module, and the second terminal of the coupling module, and a gate of the fifth transistor receiving the first emission control signal;
the second emission control module comprises a sixth transistor, a first electrode of the sixth transistor being connected to the second electrode of the driving module, a second electrode of the sixth transistor being connected to the first terminal of the light-emitting module, and a gate of the sixth transistor receiving the second emission control signal;
the anode reset module comprises a seventh transistor, a first electrode of the seventh transistor being connected to a second initialization signal line providing the second initialization voltage, a second electrode of the seventh transistor being connected to the first terminal of the light-emitting module, and a gate of the seventh transistor receiving the first scan signal, a second terminal of the light-emitting module being connected to the second power supply;
the coupling module comprises a second capacitor, a first terminal of the second capacitor being respectively connected to the data writing unit and the initialization unit, and a second terminal of the second capacitor being respectively connected to the second terminal of the first emission control module, the first terminal of the driving module, and the first terminal of the compensation module.

17. A pixel circuit, characterized by comprising: a driving module, a compensation module, a first light emission control module, a second light emission control module, an anode reset module, and a light emitting module;
a first terminal of the compensation module is connected to a first terminal of the driving module, a second terminal of the compensation module is connected to a control terminal of the driving module, and the compensation module is configured to transmit threshold voltage information of the driving module to the control terminal of the driving module, the threshold voltage of the driving module is formed after the driving module performs discharging;
the first light emission control module, the driving module, the second light emission control module, and the light emitting module are sequentially connected in series between a first power supply and a second power supply;
the first light emission control module is configured to be turned on in response to a first light emission control signal;
the anode reset module is configured to provide a second initialization voltage to a first terminal of the light emitting module in response to a first scan signal;
a type of a transistor included in the first light emission control module is opposite to a type of a transistor included in the anode reset module;
the first light emission control signal is multiplexed as the first scan signal, or, in a display panel corresponding to the pixel circuit, pixel circuits are arranged in an array, first light emission control modules of pixel circuits in a same row receive the same first light emission control signal, anode reset modules of pixel circuits in a same row receive the same first scan signal, and in two adjacent rows of pixel circuits, the first light emission control signal of the upper row is reused as the first scan signal of the lower row.

18. The pixel circuit according to claim 17, characterized by further comprising a voltage writing module and a coupling module;
a first terminal of the coupling module is connected to the voltage writing module, a second terminal of the coupling module is connected to the first terminal of the driving module, and the voltage writing module is configured to transmit a first initialization voltage and a data voltage to the first terminal of the coupling module in a time-division manner;
the coupling module is configured to couple the data voltage to the control terminal of the driving module;
the voltage writing module comprises an initialization unit and a data writing unit;
one display cycle of the pixel circuit comprises a write frame and a hold frame;
the initialization unit is connected to the first terminal of the coupling module and is configured to provide the first initialization voltage to the first terminal of the coupling module in response to a second scan signal during a first initialization phase of the write frame;
the data writing unit is connected to the first terminal of the coupling module and is configured to provide the data voltage to the first terminal of the coupling module in response to a third scan signal during a data writing phase of the write frame;
the coupling module is configured to transmit the data voltage to the control terminal of the driving module through the turned-on compensation module;
the compensation module is configured to be turned on in response to a fourth scan signal during a threshold compensation phase of the write frame, so as to transmit threshold voltage information of the driving module to the control terminal of the driving module, the threshold voltage of the driving module is generated in a path formed by the first terminal of the driving module, the driving module, the second light emission control module and the anode reset module.

19. A driving method for a pixel circuit, used for driving the pixel circuit according to claim 1, one display cycle of the pixel circuit at least comprises a write frame;
the driving method for the pixel circuit comprises:
during a first initialization phase of the write frame, the voltage writing module responds to a second scan signal to provide the first initialization voltage to the first terminal of the coupling module;
during a threshold compensation phase of the write frame, the compensation module responds to a fourth scan signal to be turned on, so as to transmit threshold voltage information of the driving module to the control terminal of the driving module, the threshold voltage of the driving module is formed after the driving module performs discharging ;
during a data writing phase of the write frame, the voltage writing module responds to a third scan signal to provide the data voltage to the first terminal of the coupling module, so that the coupling module couples the data voltage to the control terminal of the driving module.

20. The driving method for a pixel circuit according to claim 19, characterized in that the pixel circuit further comprises a light emitting module, an anode reset module, a first light emission control module, and a second light emission control module;
the driving method for the pixel circuit further comprises:
during a second initialization phase of the write frame, the anode reset module responds to a first scan signal to be turned on, so as to provide a second initialization voltage to the first terminal of the light emitting module;
during a light emitting phase of the write frame, the first light emission control module responds to a first light emission control signal to be turned on, and the second light emission control module responds to a second light emission control signal to be turned on, so that the driving module drives the light emitting module to emit light based on a driving current generated from the data voltage;
within the write frame, the first initialization phase and the data writing phase are not performed simultaneously, and the first initialization phase is earlier than the data writing phase;
for any one of the write frames, the threshold compensation phase and the data writing phase partially overlap;
a start time of the threshold compensation phase is earlier than a start time of the data writing phase, and an end time of the threshold compensation phase is earlier than an end time of the data writing phase;
for any one of the write frames, the threshold compensation phase and the first initialization phase partially overlap, and the end time of the threshold compensation phase is later than an end time of the first initialization phase;
for any one of the write frames, the second initialization phase and the threshold compensation phase partially overlap, and a start time of the second initialization phase is the same as a start time of the threshold compensation phase, and an end time of the second initialization phase is later than an end time of the threshold compensation phase, or, the start time of the second initialization phase is earlier than the start time of the
threshold compensation phase, and the end time of the second initialization phase is the same as the end time of the threshold compensation phase.
